(19) United States
(12) Patent Application Publication
(10) Pub. No.: US 2025/0111437 A1
(43) Pub. Date: Apr. 3, 2025

(54) TOKEN PORTFOLIO MIGRATION SYSTEM AND METHOD

(71) Applicant: Visa International Service Association, San Francisco, CA (US)

(72) Inventors: Kerstin Gleie, Alamo, CA (US); Christopher Jones, Greenbrae, CA (US); Ranjit Bhaskar, San Francisco, CA (US); Liping Dai, Fremont, CA (US); Geoffrey Brookman, Highlands Ranch, CO (US); Brandon Haenlein, Parker, CO (US); Mitchell Lee Wright, San Mateo, CA (US)

(73) Assignee: Visa International Service Association, San Francisco, CA (US)

(21) Appl. No.: 18/477,505

(22) Filed: Sep. 28, 2023

(51) Int. Cl. G06Q 40/06; G06Q 20/06

(52) U.S. Cl. CPC G06Q 40/06; G06Q 20/065; G06Q 2220/00

(57) ABSTRACT

A method and system for migrating a payment instrument portfolio. A payment network computer receives a payment instrument portfolio conversion request message from an issuer computer to convert a payment instrument portfolio from a prior payment instrument scheme to a new payment instrument portfolio based on a new payment instrument scheme. The request message includes information about existing payment instrument references from the prior payment instrument scheme. The payment network computer creates enrollments based on the information about the existing payment instrument references and sends a portfolio migration event notification message to a payment instrument requestor partner computer associated with a payment network payment instrument requestor identifier subscribed to a new event type for the payment instrument portfolio migration. The payment network computer receives a provision payment instrument from the payment instrument requestor partner computer and sends a new payment instrument provisioning approval request message to the issuer computer.

### TECHNICAL FIELD

The present disclosure is directed to payment card portfolio migration technique to provide a seamless and automated process to migrate network tokens of other payment card schemes to a payment network token service tokens as part of an issuer portfolio migration to the payment network. More particularly, the present disclosure is directed to payment card portfolio migration via account credential life cycle management push provisioning.

### SUMMARY

In one aspect, the present disclosure provides a method of migrating a payment instrument portfolio. The method comprising receiving, by a payment network computer, a payment instrument portfolio conversion request message from an issuer computer to convert a payment instrument portfolio from a prior payment instrument scheme to a new payment instrument portfolio based on a new payment instrument scheme, the request message comprising information about existing payment instrument references from the prior payment instrument scheme; creating, by the payment network computer, enrollments based on the information about the existing payment instrument references; sending, by the payment network computer, a portfolio migration event notification message to a payment instrument requestor partner computer associated with a payment network payment instrument requestor identifier which is subscribed to a new event type for the payment instrument portfolio migration; receiving, by the payment network computer, a provision payment instrument from the payment instrument requestor partner computer; and sending, by the payment network computer, a new payment instrument provisioning approval request message to the issuer computer.

In another aspect, the present disclosure provides a system for migrating a payment instrument portfolio. The system comprising a payment network computer comprising a processor and a memory for storing machine executable instructions that when executed by the processor cause the processor to receive a payment instrument portfolio conversion request message from an issuer computer to convert a payment instrument portfolio from a prior payment instrument scheme to a new payment instrument portfolio based on a new payment instrument scheme, the request message comprising information about existing payment instrument references from the prior payment instrument scheme; create enrollments based on the information about the existing payment instrument references; send a portfolio migration event notification message to a payment instrument requestor partner computer associated with a payment network payment instrument requestor identifier which is subscribed to a new event type for the payment instrument portfolio migration; receive a provision payment instrument from the payment instrument requestor partner computer; and send a new payment instrument provisioning approval request message to the issuer computer.

In another aspect, the present disclosure provides a system for migrating a payment instrument portfolio. The system comprising a payment network computer to create enrollments based on information about existing payment instrument references; send a portfolio migration event notification message to a payment instrument requestor partner computer associated with a payment network payment instrument requestor identifier which is subscribed to a new event type for the payment instrument portfolio migration; and receive a provision payment instrument from the payment instrument requestor partner computer.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

Methods, apparatuses, computer readable media, and systems disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates a system and a flow diagram providing an overview of various entity interactions in a tokenization ecosystem environment, according to at least one aspect of the present disclosure.

FIG. 2 is a logic flow diagram of a process for portfolio migration via PAN life-cycle-management push provisioning, according to at least one aspect of the present disclosure.

FIG. 3 is a swimlane diagram of an implementation of the process shown in FIG. 2, according to at least one aspect of the present disclosure.

FIG. 4 illustrates a block diagram of a tokenization environment portion of the token service system described in FIG. 1, according to at least one aspect of the present disclosure.

FIG. 5 shows a block diagram of a payment network computer, according to at least one aspect of the present disclosure.

FIG. 6 is a block diagram of a computer apparatus with data processing subsystems or components, according to at least one aspect of the present disclosure.

FIG. 7 is a diagrammatic representation of an example system that includes a host machine within which a set of instructions to perform any one or more of the methodologies discussed herein may be executed, according to at least one aspect of the present disclosure.

FIG. 8 is a logic flow diagram of a process for portfolio migration via PAN life-cycle-management push provisioning, according to at least one aspect of the present disclosure.

### DESCRIPTION

The following disclosure may provide example systems, devices, and methods for conducting a financial transaction and related activities. Although reference may be made to such financial transactions in the examples provided below, aspects are not so limited. That is, the systems, methods, and apparatuses may be utilized for any suitable purpose.

Before discussing specific embodiments, aspects, or examples, some descriptions of terms used herein are provided below.

“Account credential,” “account number,” “payment credential,” or “identification information” may refer to any suitable information that identifies an account or is associated with an account (e.g., a payment account and/or payment device associated with the account) that allows a payment processor to verify that a device, person, or entity has permission to access the account. Such information may be directly related to the account or may be derived from information related to the account. For example, account credentials may include an account identifier (e.g., a primary account number [PAN]), a token (e.g., account identifier substitute), an expiration date, a cryptogram, a card verification value (CVV), dynamic card verification value (dCVV), card verification value 2 (CVV2), personal information associated with an account (e.g., user name, address, expiration date, etc.), an account alias, or any combination thereof. Account credentials may be static or dynamic such that they change over time. Further, in some embodiments or aspects, the account credentials may include information that is both static and dynamic. For example, an account identifier and expiration date may be static but a cryptogram may be dynamic and change for each transaction. Further, in some embodiments or aspects, some or all of the account credentials may be stored in a secure memory of a user device. The secure memory of the user device may be configured such that the data stored in the secure memory may not be directly accessible by outside applications and a payment application associated with the secure memory may be accessed to obtain the credentials stored on the secure memory. Accordingly, a mobile application may interface with a payment application in order to gain access to payment credentials stored on the secure memory. Payment credentials may be any information that identifies or is associated with a payment account. Payment credentials may be provided in order to make a payment from a payment account. Payment credentials can also include a user name, an expiration date, a gift card number or code, and any other suitable information. “Credential” may be any suitable information that serves as reliable evidence of worth, ownership, identity, or authority. A credential may be a string of numbers, letters, or any other suitable characters that may be present or contained in any object or document that can serve as confirmation. Examples of credentials include value credentials, identification cards, certified documents, access cards, passcodes and other login information, etc. “Primary account number (PAN)” may be a variable length, (e.g., 13 to 19-digit) industry standard-compliant account number that is generated within account ranges associated with a BIN by an issuer.

“Account identifier” may refer to one or more types of identifiers associated with an account (e.g., a unique identifier of an account, an account number, a PAN, a card number, a payment card number, a token, and/or the like) of a user. In some non-limiting embodiments or aspects, an issuer may provide an account identifier (e.g., a PAN, a token, a globally unique identifier (GUID), a universally unique identifier (UUID), and/or the like) to a user that uniquely identifies one or more accounts associated with that user. In some non-limiting embodiments or aspects, an account identifier may be embodied on a payment device (e.g., a portable financial instrument, a payment card, a credit card, a debit card, and/or the like) and/or may be electronic information communicated to the user that the user may use for electronic payment transactions. In some non-limiting embodiments or aspects, an account identifier may be an original account identifier, where the original account identifier was provided to a user at the creation of the account associated with the account identifier. In some non-limiting embodiments or aspects, the account identifier may be an account identifier (e.g., a supplemental account identifier) that is provided to a user after the original account identifier was provided to the user. For example, if the original account identifier is forgotten by the user, stolen from the user, and/or the like, a supplemental account identifier may be provided to the user. In some non-limiting embodiments or aspects, an account identifier may be directly or indirectly associated with an issuer such that an account identifier may be a token that maps to a PAN or other type of identifier. Account identifiers may be alphanumeric, any combination of characters and/or symbols, and/or the like.

“Account token” may refer to an identifier that is used as a substitute or replacement identifier for an account identifier, such as a PAN. An account token may be used as a substitute or replacement identifier for an original account identifier, such as a PAN. Account tokens may be associated with a PAN or other original account identifier in one or more data structures (e.g., one or more databases and/or the like) such that they may be used to conduct a transaction without directly using the original account identifier. In some non-limiting embodiments or aspects, an original account identifier, such as a PAN, may be associated with a plurality of account tokens for different individuals or purposes. In some non-limiting embodiments aspects, account tokens may be associated with a PAN or other account identifiers in one or more data structures such that they can be used to conduct a transaction without directly using the account identifier, such as a PAN. In some examples, an account identifier, such as a PAN, may be associated with a plurality of account tokens for different uses or different purposes.

“Acquirer” may refer to an entity licensed by the transaction service provider and/or approved by the transaction service provider to originate transactions (e.g., payment transactions) using a portable financial device associated with the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

“Acquirer” typically is a business entity (e.g., a commercial bank) that has a business relationship with a particular merchant or other entity. Some entities can perform both issuer and acquirer functions. Some embodiments or aspects may encompass such single entity issuer-acquirers. An acquirer may operate an acquirer computer, which can also be generically referred to as a “transport computer”.

“Acquirer system” also may refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments or aspects, the acquirer may be authorized by the transaction service provider to assign merchant or service providers to originate transactions using a portable financial device of the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by an acquirer's payment facilitator, and/or the like. In some non-limiting embodiments or aspects, an acquirer may be a financial institution, such as a bank.

An “application” may include any software module configured to perform a specific function or functions when executed by a processor of a computer. For example, a “mobile application” may include a software module that is configured to be operated by a mobile device. Applications may be configured to perform many different functions. For instance, a “payment application” may include a software module that is configured to store and provide account credentials for a transaction. A “wallet application” may include a software module with similar functionality to a payment application that has multiple accounts provisioned or enrolled such that they are usable through the wallet application. Further, an “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.).

“Assigned token assurance method” may refer to the actual (e.g., generated) value assigned by the token service provider to the token as the result of the identification and verification (ID&V) process performed by an entity within the tokenization ecosystem. The assigned token assurance method may be provided back to the token requestor in response to the token request message. The assigned token assurance method may be different than the requested token assurance method included in the token request message.

“Authentication” is a process by which the credential of an endpoint (including but not limited to applications, people, devices, process, and systems) can be verified to ensure that the endpoint is who they are declared to be.

“Card-not-present” (CNP) merchants transaction happens when a credit card isn't physically presented to the merchant at checkout

“Communication channel” may refer to any suitable path for communication between two or more entities. Suitable communications channels may be present directly between two entities such as a payment processing network and a merchant or issuer computer, or may include a number of different entities. Any suitable communications protocols may be used for generating a communications channel. A communication channel may in some instances comprise a “secure communication channel” or a “tunnel,” either of which may be established in any known manner, including the use of mutual authentication and a session key and establishment of a secure communications session. However, any method of creating a secure communication channel may be used, and communication channels may be wired or wireless, as well as long-range, short-range, or medium-range. By establishing a secure channel, sensitive information related to a payment device (such as account number, CVV values, expiration dates, etc.) may be securely transmitted between the two entities to facilitate a transaction.

“Communication” and “communicate” may refer to the reception, receipt, transmission, transfer, provision, and/or the like of information (e.g., data, signals, messages, instructions, calls, commands, and/or the like). A communication may use a direct or indirect connection and may be wired and/or wireless in nature. As an example, for one unit (e.g., a device, a system, a component of a device or system, combinations thereof, and/or the like) to communicate with another unit means that the one unit is able to directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. For example, a first unit may be in communication with a second unit even though the first unit passively receives data and does not actively transmit data to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting embodiments or aspects, a message may refer to a packet (e.g., a data packet, a network packet, and/or the like) that includes data. It will be appreciated that numerous other arrangements are possible.

“Computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to send, receive, process, and/or output data, and normally includes a display device, a processor, a memory, an input device, a network interface, and/or the like.

“Comprising” is not intended to be limiting, but may be a transitional term synonymous with “including,” “containing,” or “characterized by.” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an embodiment or aspect, but other elements may be added and still form a construct within the scope of a claim. In contrast, the transitional phrase “consisting of” excludes any element, step, or ingredient not specified in a claim. This is consistent with the use of the term throughout the specification.

“Cryptographic algorithm” can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc. Encryption techniques may include symmetric and asymmetric encryption techniques.

“Device,” “server,” “processor,” and/or the like, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

“Gateway processing service” may refer to a service that enables transaction processing via multiple payment processing networks through a single connection to the gateway processing service. The gateway processing service may include one or more servers, data processing subsystems, networks, and operations used to deliver authorization services, exception file services, and clearing and settlement services. An authorization request message received by the gateway processing service may be routed to one of a plurality of payment processing networks according to a routing priority list. The gateway processing service may assess network connectivity of payment processing networks and may use this information in the routing of authorization request messages.

“Identification and verification (ID&V) method” may be used to ensure that the payment token is replacing a PAN that was legitimately being used by the token requestor. Examples of ID&V methods may include, but are not limited to, an account verification message, a risk score based on assessment of the primary account number (PAN) and use of one time password by the issuer or its agent to verify the account holder. Example ID&V methods may be performed using information such as a user signature, a password, an offline or online personal identification number (PIN), an offline or online enciphered PIN, a combination of offline PIN and signature, a combination of offline enciphered PIN and signature, user biometrics (e.g. voice recognition, fingerprint matching, etc.), a pattern, a glyph, knowledge-based challenge responses, hardware tokens (multiple solution options), one time passwords (OTPs) with limited use, software tokens, two-channel authentication processes (e.g., via phone), etc. Using the ID&V, a confidence level may be established with respect to the token to PAN binding.

“Interface” may include any software module configured to process communications. For example, an interface may be configured to receive, process, and respond to a particular entity in a particular communication format. Further, a computer, device, and/or system may include any number of interfaces depending on the functionality and capabilities of the computer, device, and/or system. In some embodiments or aspects, an interface may include an application programming interface (API) or other communication format or protocol that may be provided to third parties or to a particular entity to allow for communication with a device. Additionally, an interface may be designed based on functionality, a designated entity configured to communicate with, or any other variable. For example, an interface may be configured to allow for a system to field a particular request or may be configured to allow a particular entity to communicate with the system.

“Issuer” can include a payment account issuer. The payment account (which may be associated with one or more payment devices) may refer to any suitable payment account (e.g. credit card account, a checking account, a savings account, a merchant account assigned to a consumer, or a prepaid account), an employment account, an identification account, an enrollment account (e.g. a student account), etc.

“Issuer institution,” “portable financial device issuer,” “issuer,” or “issuer bank” may refer to one or more entities that provide one or more accounts (e.g., a credit account, a debit account, a credit card account, a debit card account, and/or the like) to a user (e.g., customer, consumer, and/or the like) for conducting transactions (e.g., payment transactions), such as initiating credit and/or debit payments. For example, an issuer may provide an account identifier, such as a personal account number (PAN), to a user that uniquely identifies one or more accounts associated with the user. The account identifier may be used by the user to conduct a payment transaction. The account identifier may be embodied on a portable financial device, such as a physical financial instrument, e.g., a payment card, and/or may be electronic and used for electronic payments. In some non-limiting embodiments or aspects, an issuer may be associated with a bank identification number (BIN) that uniquely identifies the issuer. As used herein “issuer system” or “issuer institution system” may refer to one or more systems operated by or operated on behalf of an issuer. For example, an issuer system may refer to a server executing one or more software applications associated with the issuer. In some non-limiting embodiments or aspects, an issuer system may include one or more servers (e.g., one or more authorization servers) for authorizing a payment transaction.

“Key” may refer to a piece of information that is used in a cryptographic algorithm to transform input data into another representation. An example encryption key may include a master derivation key (MDK) which may be used to generate a limited use key (LUK) that is provided to a computer device of a user. An LUK can be an encryption key that is intended for limited use (e.g., a limited number of transactions or a limited time period) and is not intended to be used for the lifetime of an account. Further details regarding LUKs can be found in U.S. Published Patent Application No. 2015/0180836, which is herein incorporated by reference in its entirety and is assigned to the same assignee as the present application. The MDK may be used to generate and provision the token, as well as, authenticate the token when used in authorization processing by validating static and variable transaction data.

“Key check value (KCV)” may refer to value obtained by passing a data value through a non-reversible algorithm. The key check value may be calculated using a cryptographic algorithm which takes as input a secret key and an arbitrary string, and which gives a cryptographic check value as output. The computation of a correct check value without knowledge of the secret key is not feasible.

“Merchant” may refer to one or more individuals or entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein “merchant system” may refer to one or more computer systems operated by or on behalf of a merchant, such as a server computer executing one or more software applications.

“Merchant application” may include any application associated with a relying party to a transaction. For example, a merchant mobile application may be associated with a particular merchant or may be associated with a number of different merchants. In some embodiments or aspects, the merchant mobile application may store information identifying a particular merchant server computer that is configured to provide a sales environment in which the merchant server computer is capable of processing remote transactions initiated by the merchant application. Further, the merchant mobile application may also include a general purpose browser or other software designed to interact with one or more merchant server computers. In some cases, the merchant mobile application may be installed in the general purpose memory of a user device and thus, may be susceptible to malicious attacks.

“Merchant category code” (MCC) may refer to a numerical indication of a type of business classified according to the goods or services the business provides, such as “supermarket,” “quick service restaurant,” or “fuel dispenser.” Different rates may be charged by a payment processing network depending on the MCC generating the transaction. A user may generate transactions having different associated MCC values and may wish to generate different routing priority lists for each MCC. A merchant verification value (MVV) may be a customizable value, such as a numerical indication of a region or a particular store.

“PAN lifecycle” may refer to a re-issuance or replacement of the physical financial instrument, e.g., a payment card, and enables issuers to update PAN and PAN expiration date.

“PAN lifecycle message” may refer to the process of the issuer communicating changes to the PAN and PAN expiration date to the payment network.

“Payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway and/or to a payment gateway itself. The term “payment gateway mobile application” may refer to one or more electronic devices and/or one or more software applications configured to provide payment services for transactions (e.g., payment transactions, electronic payment transactions, and/or the like).

“Payment network” may refer to an electronic payment system used to accept, transmit, or process transactions made by payment devices for money, goods, or services. The payment network may transfer information and funds among issuers, acquirers, merchants, and payment device users. One illustrative non-limiting example of a payment network is VisaNet, which is operated by Visa, Inc.

“Payment processing network” may refer to a system that receives accumulated transaction information from the gateway processing service, typically at a fixed time each day, and performs a settlement process. Settlement may involve posting the transactions to the accounts associated with the payment devices used for the transactions and calculating the net debit or credit position of each user of the payment devices. An example payment processing network is Interlink®. A “payment token issuer identifier” may include any series of characters, numbers, or other identifiers that may be used to identify an issuer associated with a payment token. For example, a payment token issuer identifier may include a token BIN that identifies a particular issuer associated with an account identified using the token. In some embodiments or aspects, a payment token issuer identifier may be mapped to a real issuer identifier (e.g., a BIN) for an issuer. For example, a payment token issuer identifier may include a six digit numerical value that may be associated with an issuer. For instance, any token including the payment token issuer identifier may be associated with a particular issuer. As such, the issuer may be identified using the corresponding issuer identifier range associated with the token issuer identifier. For example, a payment token issuer identifier “490000” corresponding to a payment token “4900 0000 0000 0001” can be mapped to an issuer identifier “414709” corresponding to a payment account identifier “4147 0900 0000 1234.” In some embodiments or aspects, a payment token issuer identifier is static for an issuer. For example, a payment token issuer identifier (e.g., “490000”) may correspond to a first issuer and another payment token issuer identifier (e.g., “520000”) may correspond to a second issuer, and the first and second payment token issuer identifiers may not be changed or altered without informing all entities within the network token processing system. In some embodiments or aspects, a payment token issuer identifier range may correspond to an issuer identifier. For example, payment tokens including payment token issuer identifiers from “490000”-“490002” may correspond to a first issuer (e.g., mapped to issuer identifier “414709”) and payment tokens including payment token issuer identifiers from “520000”-“520002” may correspond to a second issuer (e.g., mapped to real issuer identifier “417548”).

“Processing network” may include an electronic system used to accept, transmit, or process transactions made by devices. The processing network may transfer information among transacting parties (e.g., issuers, acquirers, merchants, device users, etc.).

“Provisioning” may include a process of providing data for use. For example, provisioning may include providing, delivering, or enabling a token on a device. Provisioning may be completed by any entity within or external to the transaction processing system. For example, in some embodiments or aspects, tokens may be provisioned by an issuer or a payment processing network onto a mobile device of a consumer (e.g. account holder). The provisioned tokens may have corresponding token data stored and maintained in the token vault or token registry. In some embodiments or aspects, a token vault or token registry may generate a token that may then be provisioned or delivered to a device. In some embodiments or aspects, an issuer may specify a token range from which token generation and provisioning can occur. Further, in some embodiments or aspects, an issuer may generate and notify a token vault of a token value and provide the token record information (e.g., token attributes) for storage in the token vault.

“Push provisioning” is a capability that enables cardholders to “push” a token from the issuer experience into a destination wallet or merchant.

A “requestor” may be an entity that can request an item or action. A requestor may be an application, a device, or a system that is configured to perform actions associated with tokens. For example, a requestor can request registration with a network token system, request token generation, token activation. token de-activation, token exchange, other token life-cycle management related processes, and/or any other token related processes. A requestor may interface with a network token system through any suitable communication networks and/or protocols (e.g., using HTTPS, simple object access protocol (SOAP) and/or an extensible markup language (XML) interface). Some non-limiting examples of a requestor may include third party wallet providers, issuers, acquirers, merchants, and/or payment processing networks.

A requestor may be referred to as a “token requestor” when requesting generation of a new token or requesting a new use of an existing token from a network token system. In some embodiments or aspects, a token requestor can request tokens for multiple domains and/or channels. Some non-limiting examples of token requestors may include, for example, card-on-file merchants, acquirers, acquirer processors, and payment gateways acting on behalf of merchants, payment enablers (e.g., original equipment manufacturers, mobile network operators, etc.), digital wallet providers, issuers, third party wallet providers, and/or payment processing networks. A token requestor may refer to an entity that is seeking to implement tokenization according to embodiments or aspects of the present disclosure. The token requestor may initiate a request that a primary account number (PAN) be tokenized by submitting a token request message to the token service provider. According to various embodiments or aspects discussed herein, a token requestor may no longer need to store a PAN associated with a token once the requestor have received the token in response to a token request message. A token requestor may be registered and identified uniquely by the token service provider within the tokenization ecosystem. During token requestor registration, the token service provider may formally process token requestor's application to participate in the token service system. The token service provider may collect information pertaining to the nature of the requestor and relevant use of tokens to validate and formally approve the token requestor and establish appropriate domain restriction controls. Successfully registered token requestors may be assigned a token requestor identifier that may also be entered and maintained within the token vault. Token requestors be revoked or assigned new token requestor identifiers. This information may be subject to reporting and audit by the token service provider.

“Server computer” may typically be a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. In some embodiments or aspects, the server computer may provide and/or support payment network cloud service.

“System” may refer to one or more computing devices or combinations of computing devices (e.g., processors, servers, client devices, software applications, components of such, and/or the like).

“Token” or “payment token” may include an identifier for a payment account that is a substitute for an account identifier, such as a PAN. For example, a token may include a series of numeric and/or alphanumeric characters that may be used as a substitute for an original account identifier. For example, a token “4900 0000 0000 0001” may be used in place of a PAN “4147 0900 0000 1234.” In some embodiments or aspects, a token may be “format preserving” and may have a numeric format that conforms to the account identifiers used in existing payment processing networks (e.g., ISO 8583 financial transaction message format). In some embodiments or aspects, a token may be used in place of a PAN to initiate, authorize, settle or resolve a payment transaction or represent the original credential in other systems where the original credential would typically be provided. In some embodiments or aspects, a token value may be generated such that the recovery of the original PAN or other account identifier from the token value may not be computationally derived. For example, a token may have a random association with a particular real PAN so that the real PAN is not computationally derivable from the token. A lookup table may be used to associate a real PAN and a corresponding random token. Further, in some embodiments or aspects, the token format may be configured to allow the entity receiving the token to identify it as a token and recognize the entity that issued the token.

According to various embodiments or aspects, a token may be associated with a token status. The token status may indicate, for example, that the token is a high quality token or a low quality token. The status of the token may be indicative of a level of restriction associated with the token. For example, no restrictions may be imposed on a high quality token whereas restrictions such as further identification requirements may be imposed on a low quality token. The status of the token may be based at least in part on the confidence level with which the token is generated.

In some embodiments or aspects, tokens may be device-specific such that each device associated with an account may be provisioned with a particular token. As such, if a transaction uses a token that is initiated by a different device than the device that the token was provisioned into, the transaction may be fraudulent. Accordingly, device information may be stored in the token vault and used to ensure that the device used in a transaction is associated with the token that is being used in the transaction. Additionally, because each token may be associated with a single device, one PAN or account may have multiple tokens associated with it, where each PAN may have a different token for the different devices that may be used to initiate a transaction associated with the PAN using a specific token. This provides additional security for transactions because network token systems have additional information to validate in order to control the use of sensitive information in a transaction processing system. A number of tokens can include a number of dynamic tokens that can be requested for the same account identifier (e.g., PAN) and/or same device at one time. In some embodiments or aspects, the number of tokens can be optionally provided to the token requestor at the time of a token generation request. In some embodiments or aspects, tokens may be provided with overlapping time to live (TTL) so that one or more tokens may be active at any given time.

In some embodiments or aspects, the token format may allow entities in the payment system to identify the issuer associated with the token. For example, the format of the token may include a token issuer identifier that allows an entity (e.g. the payment processing network) to identify an issuer of the token. For instance, the token issuer identifier may be associated with an issuer's BIN of the underlying PAN in order to support the existing payment flow. The token issuer identifier may be a different number than the issuer's BIN and may be static. For example, if the issuer's BIN for an issuer is 412345, the token issuer identifier may be a token BIN of 428325 and this number may be static for all tokens issued from or for that issuer. In some embodiments or aspects, the token issuer identifier range (e.g., issuer token BIN range) may have the same attributes as the associated issuer card range and can be included in an issuer identifier routing table (e.g., BIN routing table). The issuer identifier routing table may be provided to the relevant entities in the payment system (e.g., merchants and acquirers).

“Tokenization” is a process by which data is replaced with substitute data. For example, a payment account identifier (e.g., a primary account number (PAN)) may be tokenized by replacing the primary account identifier with a substitute number (e.g. a token) that may be associated with the payment account identifier. Further, tokenization may be applied to any other-information which may be replaced with a substitute value (e.g., token, a credit card verification value (CVV)). Tokenization may be used to enhance transaction efficiency, improve transaction security, increase service transparency, or to provide a method for third-party enablement.

A “token assurance method” may refer to an indicator or a value that allows the token service provider to indicate the confidence level of the token to PAN binding. The token assurance method may be determined by the token service provider based on the type of identification and verification (ID&V) performed and the entity that performed the ID&V. The token assurance method may be set when issuing the token. The token assurance method may be updated if additional ID&V is performed.

“Token attributes” may include any feature or information about a token. For example, token attributes may include information that can determine how a token can be used, delivered, issued, or otherwise how data may be manipulated within a transaction system. For example, token attributes may determine how a token may be used in place of a real account identifier (e.g., PAN) for a transaction. For example, the token attributes may include a type of token, frequency of use, token expiry date and/or expiry time, a number of associated tokens, a transaction lifecycle expiry date, and any additional information that may be relevant to any entity within a tokenization ecosystem. For example, token attributes may include a wallet identifier associated with the token, an additional account alias or other user account identifier (e.g., an email address, username, etc.), a device identifier, an invoice number, etc. In some embodiments or aspects, a token requestor may provide token attributes at the time of requesting the generation of tokens. In some embodiments or aspects, a network token system, payment network associated with the network token system, an issuer, or any other entity associated with the token may determine and/or provide the token attributes associated with a particular token.

The token attributes may identify a type of token indicating how the token may be used. For example, a type of token may be “payment” or “non-payment” to identify the token as being a payment token or a non-payment token. A payment token may include a high value token that can be used in place of a real account identifier (e.g., PAN) to generate original and/or subsequent transactions for a consumer account and/or card.

Another token type may be a “static” or “dynamic” token type for static and dynamic tokens, respectively. For example, a static token may include a token that may be issued by a payment processing network or issuer that may be issued in place of an account identifier (e.g., PAN) and may be used for the duration of the underlying account identifier (e.g., PAN). As such, static tokens may be used to submit any number of transactions and may not change for each transaction. Static tokens may be securely stored on the consumer device (e.g., stored in a secure memory or secure element of a mobile device) or in the cloud by the token requestor and may be delivered securely to a mobile device. However, static tokens may include sensitive information that may be protected as they may be used to perform multiple transactions over long periods of time.

Alternatively, dynamic tokens can include tokens that are limited or restricted in use (e.g., limited by time, amount threshold (aggregated amount or single-transaction amount), or by number of uses). As such, dynamic tokens can be generated and delivered on a per-transaction or on an as needed basis to the end user to initiate a payment transaction through a registered and authenticated device and/or channel. For example, a one-time use dynamic token can be used at electronic-commerce (e-commerce) websites and if the dynamic token is intercepted by a third party, the dynamic token may be useless because it has been used and is thus worthless for future transactions.

Non-payment tokens may include tokens which are not substitutes for real account identifiers (e.g., PANs). For example, non-payment tokens may be used by merchant/acquirer systems for analytics, offers, customer support, marketing, etc. However, non-payment tokens may not be used to generate original and subsequent transactions using real account identifiers (e.g., PANs) or other account identifiers. Accordingly, non-payment tokens may include low value tokens that may be used for non-payment transactions or transaction services by an entity within the transaction processing system.

A “token BIN” may refer to a specific BIN that has been designated only for the purpose of issuing tokens and may be flagged accordingly in BIN tables. Token BINs may not have a dual purpose and may not be used to issue both primary account numbers (PANs) and tokens.

A “token domain” may indicate the factors that can be established at the time of token issuance to enable appropriate usage of the token for payment transactions. A token domain may indicate an area and/or circumstance in which a token can be used. Examples of the token domain may include, but are not limited to, payment channels (e.g., e-commerce, physical point of sale, etc.), a POS entry modes (e.g., contactless, magnetic stripe, etc.), and merchant identifiers to uniquely identify where the token can be used. A set of parameters (e.g., token domain restriction controls) may be established as part of token issuance by the token service provider that may allow for enforcing appropriate usage of the token in payment transactions. For example, the token domain restriction controls may restrict the use of the token with particular presentment modes, such as contactless or e-commerce presentment modes. In some embodiments or aspects, the token domain restriction controls may restrict the use of the token at a particular merchant that can be uniquely identified. Some example token domain restriction controls may require the verification of the presence of a token cryptogram that is unique to a given transaction. In some embodiments or aspects, a token domain can be associated with a token requestor.

“Token exchange” or “de-tokenization” is a process of restoring the data that was substituted during tokenization. For example, a token exchange may include replacing a payment token with a corresponding primary account number (PAN) that was associated with the payment token during tokenization of the PAN. Thus, the de-tokenization may refer to the process of redeeming a token for the associated PAN value based on a token-to-PAN mapping stored, for example, in a token vault. The ability to retrieve a PAN in exchange for the associated token may be restricted to specifically authorized entities, individuals, applications, or systems. Further, de-tokenization or token exchange may be applied to any other information. In some embodiments or aspects, token exchange may be achieved via a transactional message, such as an ISO message, an application programming interface (API), or another type of web interface (e.g., web request).

“Token expiry date” may refer to the expiration date/time of the token that is generated by the token service provider and maintained in the token vault. The token expiry date may be passed among the entities of the tokenization ecosystem during transaction processing to ensure interoperability and minimize the impact of tokenization implementation. The token expiration date may be a numeric value (e.g. a 4-digit numeric value) that is consistent with the industry standards. In some embodiments or aspects, the token expiry date can be expressed as a time duration as measured from the time of issuance. A token expiration date and/or expiration time can determine a duration (e.g., days/hours/minutes) for which a token is valid. In some embodiments or aspects, a token expiration date may match the underlying account identifier's (e.g., PAN's) expiration date. In some embodiments or aspects, token expiration date may be defined as less than the associated real account identifier's (e.g., PAN's) expiration date. If a transaction is initiated after a token's expiration date, the token can be deemed as invalid and the transaction initiated with the corresponding token can be declined.

A life-cycle expiration date may include a time or date where the network token system may recycle or reuse a previously issued token. For example, the life-cycle expiration date may be maintained by the network token system for the entire life-cycle of a token once a token has been used for a transaction. This can allow various entities to submit subsequent transactions (or other service requests) with the token for a set period. Once this period is expired, the expired token can be recycled for re-use.

“Token interoperability” may refer to a process to ensure that the processing and exchanging of transactions between parties through existing interoperable capabilities is preserved when using tokens with new data fields and data field values that are defined in embodiments or aspects of the present disclosure.

“Token issuer identifier range (issuer BIN range)” may refer to a unique identifier (e.g., of 6 to 12 digits length) originating from a set of pre-allocated token issuer identifiers (e.g., 6 digit token BINs). For example, in some embodiments or aspects, one or more token BIN ranges can be allocated to each issuer BIN range that is associated with an issuer. In some embodiments or aspects, the token BIN ranges may be used to generate a payment token and may not be used to generate a non-payment token. As such, the non-payment tokens may comprise different token issuer identifiers or may not comprise token issuer identifiers. In some embodiments or aspects, a token may pass the basic validation rules of an account number including, for example, a LUHN check or checksum validation that may be set up by different entities within the payment system. In some embodiments or aspects, a payment token issuer identifier may be mapped to a real issuer identifier (e.g., a BIN) for an issuer. For example, a payment token issuer identifier may include a six digit numerical value that may be associated with an issuer. For instance, any token including the payment token issuer identifier may be associated with a particular issuer. As such, the issuer may be identified using the corresponding issuer identifier range associated with the token issuer identifier. For example, a payment token issuer identifier “540000” corresponding to a payment token “5400 0000 0000 0001” can be mapped to an issuer identifier “553141” corresponding to a payment account identifier “553141 0900 0000 1234”. In some embodiments or aspects, a payment token issuer identifier is static for an issuer. For example, a payment token issuer identifier (e.g., “540000”) may correspond to a first issuer and another payment token issuer identifier (e.g., “550000”) may correspond to a second issuer, and the first and second payment token issuer identifiers may not be changed or altered without informing all entities within the network token processing system. In some embodiments or aspects, a payment token issuer identifier range may correspond to an issuer identifier. For example, payment tokens including payment token issuer identifiers from “490000”-“490002” may correspond to a first issuer (e.g., mapped to issuer identifier “414709”) and payment tokens including payment token issuer identifiers from “520000”-“520002” may correspond to a second issuer (e.g., mapped to real issuer identifier “517548”). Token BIN Ranges and assignment of tokens from these BIN ranges may be made available to the parties accepting the transaction to make routing decisions.

“Token presentment mode” may indicate a method through which a token is submitted for a transaction. Some non-limiting examples of the token presentment mode may include machine readable codes (e.g., quick response code (QRC), barcode, etc.), mobile contactless modes (e.g., near-field communication (NFC) communication), e-commerce remote modes, e-commerce proximity modes, and any other suitable modes in which to submit a token. Tokens may be provided through any number of different methods. For example, in one implementation, a token may be embedded in machine-readable code which may be generated by a wallet provider, mobile application, or other application on mobile device and displayed on a display of the mobile device. The machine readable code can be scanned at the POS through which the token is passed to the merchant. A mobile contactless mode may include passing the token through NFC in a contactless message. An e-commerce remote mode may include submitting a token by a consumer or a wallet provider through an online transaction or as an e-commerce transaction using a merchant application or other mobile application. An e-commerce proximity mode may include submitting a token by a consumer from a wallet application on a mobile device at a merchant location.

The token presentment mode may include any identifier or method for indicating the mode through which a token is provided. For example, the token presentment mode may include a number associated with a particular type of transaction (e.g., 5 for NFC transaction, 3 for QR Code, etc.). Further, in some embodiments or aspects, the token presentment mode could be provided through a type of cryptogram or other dynamic data generated for a transaction. For example, each type of transaction presentment mode may have a different cryptogram algorithm associated with that type of presentment mode (e.g., NFC vs. QR Code), and the type of cryptogram used by be determined during validation of the cryptogram. Additionally, a token presentment mode may be provided by a mobile device or may be populated by a merchant access device (e.g., a POS terminal) or other entity within the transaction processing system (e.g., acquirer computer, merchant processor, etc.).

“Token Processing” may refer to transaction processing in which a token is present in lieu of the primary account number (PAN). The token is processed from the point of interaction throughout the network. The token processing further includes using the token vault for de-tokenization of the token in order to complete the transaction. Token processing may span payment processes that include authorization, capture, clearing, and exception processing.

“Token request message” may be an electronic message for requesting a token. A token request message may include information usable for identifying a payment account or digital wallet, and/or information for generating a payment token. For example, a token request message may include payment credentials, mobile device identification information (e.g. a phone number or MSISDN), a digital wallet identifier, information identifying a tokenization service provider, a merchant identifier, a cryptogram, and/or any other suitable information. Information included in a token request message can be encrypted (e.g., with an issuer-specific key). In some embodiments or aspects, a token request message may be formatted as an authorization request message (e.g., an ISO 8583 message format). In some embodiments or aspects, the token request message may have a zero dollar amount in an authorization amount field. As another example, the token request message may include a flag or other indicator specifying that the message is a token request message.

“Token request indicator” may refer to an indicator used to indicate that the message containing the indicator is related to a token request. The token request indicator may optionally be passed to the issuer as part of the Identification and Verification (ID&V) method to inform the issuer of the reason the account status check is being performed.

“Token requestor identifier (ID)” may include any characters, numerals, or other identifiers associated with an entity associated with a network token system. For example, a token requestor identifier may be associated with an entity that is registered with the network token system. In some embodiments or aspects, a unique token requestor ID may be assigned for each domain for a token request associated with the same token requestor. As such, in some embodiments or aspects, if a token requestor may request tokens for multiple domains, the token requestor may have multiple token requestor identifiers, one for each domain. For example, a token requestor ID can identify a pairing of a token requestor (e.g., a mobile device, a mobile wallet provider, etc.) with a token domain (e.g., e-commerce, contactless, etc.). A token requestor ID may include any format or type of information. For example, in one embodiment or aspect, the token requestor ID may include an alphanumerical value such as a ten digit or an eleven digit letter and/or number (e.g., 4678012345). In some embodiments or aspects, a token requestor ID may include a code for a token service provider (e.g., first 3 digits) such as the network token system and the remaining digits may be assigned by the token service provider for each requesting entity (e.g., mobile wallet provider) and the token domain (e.g., contactless, e-commerce, etc.).

In some embodiments or aspects, a token requestor identifier may be used in a transaction during authorization processing. For example, a token requestor identifier may be passed through a transaction request message to validate that the entity that is initiating the transaction is the same as the entity that requested and manages the token. In some embodiments or aspects, an entity (e.g., digital or mobile wallet provider, merchant, merchant of record, payment enabler, etc.) can be assigned a token requestor identifier during an on-boarding or registration process. In some embodiments or aspects, an acquirer/acquirer processor/payment enabler (e.g., payment service provider) may populate the token requestor identifier for each merchant, mobile wallet provider, consumer, etc. into the authorization message field prior to submitting the authorization request message to a payment processing network.

“Token response message” may be a message that responds to a token request. A token response message may include an indication that a token request was approved or denied. A token response message may also include a payment token, mobile device identification information (e.g. a phone number or MSISDN), a digital wallet identifier, information identifying a tokenization service provider, a merchant identifier, a cryptogram, and/or any other suitable information. Information included in a token response message can be encrypted (e.g., with an issuer-specific key). In some embodiments or aspects, a token response message may be formatted as an authorization response message (e.g., an ISO 8583 message format). In some embodiments or aspects, the token response message may have a zero dollar amount in an authorization amount field. As another example, the token response message may include a flag or other indicator specifying that the message is a token response message.

“Token service provider” may refer to an entity including one or more server computers in a token service system that generates, processes and maintains tokens. The token service provider may include or be in communication with a token vault where the generated tokens are stored. Specifically, the token vault may maintain one-to-one mapping between a token and a primary account number (PAN) represented by the token. The token service provider may have the ability to set aside licensed BINs as token BINs to issue tokens for the PANs that may be submitted to the token service provider. Various entities of a tokenization ecosystem may assume the roles of the token service provider. For example, payment networks and issuers or their agents may become the token service provider by implementing the token services according to embodiments or aspects of the present disclosure. A token service provider may provide reports or data output to reporting tools regarding approved, pending, or declined token requests, including any assigned token requestor IDs. The token service provider may provide data output related to token-based transactions to reporting tools and applications and present the token and/or PAN as appropriate in the reporting output.

“Token service system” refers to a system that facilitates requesting, generating and/or issuing tokens, as well as maintaining an established mapping of tokens to primary account numbers (PANs) in a repository (e.g. token vault). In some embodiments or aspects, the token service system may establish a token assurance method for a given token to indicate the confidence level of the token to PAN binding. The token service system may support token processing of payment transactions submitted using tokens by de-tokenizing the token to obtain the actual PAN. In various embodiments or aspects, the token service system may include a token requestor and a token service provider interacting with the token requestor. In some embodiments or aspects, a token service system may include a tokenization computer alone, or in combination with other computers such as a transaction processing network computer.

“Token vault” may refer to a repository that maintains established token-to-PAN mappings. According to various embodiments or aspects, the token vault may also maintain other attributes of the token requestor that may be determined at the time of registration and that may be used by the token service provider to apply domain restrictions or other controls during transaction processing. For example, the token vault may maintain one-to-one mapping between a token and an account identifying number represented by the token. The token vault may be a part of the token service system. In some embodiments or aspects, the token vault may be provided as a part of the token service provider. Alternatively, the token vault may be a remote repository accessible by the token service provider. Token vaults, due to the sensitive nature of the data mappings that are stored and managed in them, may be protected by strong underlying physical and logical security.

“User” may include an individual. In some embodiments or aspects, a user may be associated with one or more personal accounts and/or mobile devices. The user may also be referred to as a cardholder, account holder, or consumer.

Facilitating payment card portfolio migration from a prior payment network to a new payment network plays an important role for payment networks to win new issuer business. Issuers rely largely on consumer engagement during the payment card activation process to register their new card with wallets and merchants with very limited automation. Current acquirers support portfolio migration as part of a card replacement process (Old PAN: PAN from prior scheme to New PAN: payment network PAN). Current token requestors/token requestor token service providers allow an issuer to delete tokens from a prior scheme and push provisioning for new payment network PANs. Migrating an issuer payment card portfolio entails migrating the payment card portfolio from a prior scheme to a new scheme and migrating tokens created by the prior scheme to a new token service scheme.

In conventional card migration techniques, the cardholders manually enter the details of a new card at any merchant who had stored their payment card from a different card scheme. This requires the merchant/merchant gateway to send a provisioning request to the new payment network token service in order to receive a new token. For issuers, it is not transparent that the provisioning request sent by the merchant/merchant gateway is related to the migration of the prior card scheme's network token to a new payment network token service.

PAN lifecycle management (issuer provided changes on underlying PAN details) is currently a completely separate process from the issuer-initiated creation of a new token (“push provisioning”). The proposed methods, apparatuses, computer readable media, and systems combine the two processes and allows the issuer to use a PAN lifecycle request to initiate the creation of a new token in one single process flow.

The proposed methods, apparatuses, computer readable media, and systems introduce a new “portfolio migration event” notification API that allows a proactive outreach to acceptance partners such as acquirers, merchant gateways, and merchants to inform them about the change of payment scheme and allows them to act upon this new information and thus avoid authorization declines (on the old credential) and ensure payment continuity through the transition to move the issuer portfolio to the new payment network.

By providing a one-time transaction identifier (“Tran ID”), acquirers will be able to seamlessly continue existing merchant-initiated transactions such as recurring payments and subscriptions on the new payment network credential without having to add friction to the process and avoid the need to engage with the cardholder to provide approval (via a cardholder initiated transaction [CIT]) to continue the payments.

Issuers will be able to track the progress of the portfolio migration for card-not-present (CNP) merchants by connecting the provisioning approval request they will receive for the new network token to the initial lifecycle request (by providing a reference to former scheme's credential).

According to various aspects, the present disclosure provides methods, apparatuses, computer readable media, and systems to facilitate and support migration of credential-on-file network tokens stored by eCommerce merchants and/or their merchant gateways. The methods, apparatuses, computer readable media, and systems disclosed herein are directed to implementing and providing a network token system including token service interoperability formats and functionality that allows for generation, verification, validation, and use of tokens between payment processing networks. Tokens include surrogate values that replace the PANs in a payment ecosystem. Payment tokens may be used to originate payment transactions.

In various aspects, the methods, apparatuses, computer readable media, and systems disclosed herein provide a seamless automated process for migrating tokens issued in a prior payment card scheme to a new network token system. More particularly, the methods, apparatuses, computer readable media, and systems disclosed herein provide card portfolio migration via account credential life cycle management push provisioning.

In various aspects, the methods, apparatuses, computer readable media, and systems disclosed herein allow account credential lifecycle management such as PAN lifecycle management, for example, to initiate a push provisioning from a payment network event. In one aspect, the system and method provides an extension of prior functionality of the PAN lifecycle API in the payment network token service that currently allows issuers to communicate the replacement of a prior payment network card/PAN with a new payment network card/PAN. The extended functionality enables the PAN lifecycle API to replace a PAN/token from a prior payment card/payment network scheme with a PAN/token from a new payment network, enroll the new payment network PAN/token to the new payment network token service, and proactively communicate the information to affected token requestors of the new payment network that currently store the prior token scheme that a new payment network PAN has replaced the prior payment card.

In various aspects, the methods, apparatuses, computer readable media, and systems disclosed herein create a new token requestor notification type referred to as, for example, “portfolio migration” (API) containing a current token push provisioning event request data plus other scheme metadata in the request body, allowing the token requestor to proceed with the provisioning of a new payment network token and registering the token to the prior consumer that is associated with the previous token scheme.

In various aspects, the methods, apparatuses, computer readable media, and systems disclosed herein include the previous token reference scheme in the token provisioning approval request to the issuer to notify the issuer that the token provisioning is related to the payment card portfolio migration.

In various aspects, the methods, apparatuses, computer readable media, and systems disclosed herein provide a payment card portfolio migration tool to allow a seamless and automated process for migrating payment network tokens of prior payment card schemes to a new payment network token service tokens as part of an issuer portfolio migration to the new payment network. The system and method according to one aspect of the present disclosure replaces a currently entirely manual process that relies on the cardholder to key/enter in their new payment network card credentials at CNP merchants, while simultaneously providing issuers better visibility to the credential migration/replacement timing.

In various aspects, the methods, apparatuses, computer readable media, and systems disclosed herein employ a PAN lifecycle message to initiate a push provisioning event from the new payment network card enrollment hub. In various aspects, the system and method according to the present disclosure provides a proactive “portfolio migration” notification to the acceptance partner to initiate the process of moving from the prior payment card token scheme to a new payment card token scheme without cardholder involvement. In various aspects, the system and method according to the present disclosure provides issuers visibility whenever a token from the prior payment network token scheme is replaced by a new payment network token scheme.

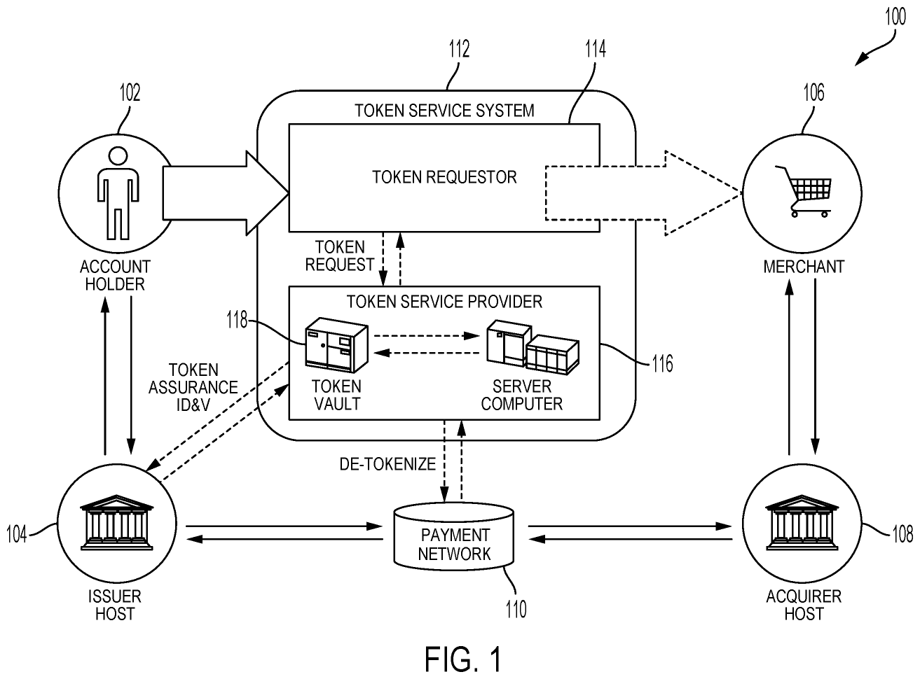

FIG. 1 illustrates a system and a flow diagram providing an overview of various entity interactions in a tokenization ecosystem environment 100, according to at least one aspect of the present disclosure. The tokenization ecosystem environment 100 may include an account holder 102, a merchant 106, an acquirer host 108, a payment network 110, and an issuer host 104. A token requestor 114 and a token service provider 116 may form a token service system 112, which is also a part of the tokenization ecosystem environment 100. The token service provider 116 may include a token vault 118 and a server computer 120. As will be discussed below, various entities of the tokenization ecosystem environment 100 may assume the role of the token requestor 114. Similarly, different entities of the tokenization ecosystem environment 100 may assume the role(s) of the token service provider 116. The roles for each of these entities will be described next in more detail.

The issuer host 104 may represent an issuer processor of a business entity (e.g., a bank) that may have issued an account (e.g., credit account, debit account, etc.) for payment transactions. In some implementations, the business entity (bank) associated with the issuer host 104 also may function as an acquirer host 108. The issuer host 104 may issue an account represented by a primary account number (PAN) to an account holder 102, upon request of the account holder 102. The account holder 102 may use the account to conduct payment transactions. The issuer host 104 may be responsible for authorization and ongoing risk management in the tokenization ecosystem environment 100. The issuer host 104 may need to accommodate any data fields provided in messages passed to and from the issuer, as defined in the disclosed embodiments in order to properly process payment transaction requests.

The account holder 102 may wish to conduct a payment transaction with a merchant 106 using the account (represented by the PAN) issued by the issuer host 104. For security purposes discussed herein, the account holder 102 may not wish to share the PAN with the merchant 106. Accordingly, a token representing the PAN may be generated by the token network service system 112 and passed to the merchant 106 server or computer.

In some embodiments, the token may be passed through a near field communication (NFC) (e.g., point-of-sale use case). Yet in other embodiments, the merchant 106 may already know the PAN of the account holder 102 (e.g., card-on-file use case). For example, the card-on-file merchant may store the account information of the account holder 102 on file (e.g., at a merchant database) for future payment purposes, such as various types of periodic payments (e.g., monthly utilities payments). In some implementations, an account holder 102 may register with one or more than one merchant 106 for card-on-file services. If the merchant 106 is a card-on-file merchant, then the merchant 106 may be the token requestor 114. When the merchant 106 is the token requestor 114, the merchant 106 may need to accommodate the implementation of token service APIs that may be referenced herein.

According to various embodiments, card-on-file merchants, acquirers, acquirer processors, payment gateways on behalf of merchants, payment enablers (e.g., original equipment manufacturer (OEM) device manufacturers), digital wallet providers or issuers may assume the role(s) of the token requestor 114. The token requestor 114 may register with the token service provider 116 (e.g., a server computer 120 of the token service provider 116). After successful registration with the token service provider 116, the token requestor 114 may be assigned a token requestor ID. The token requestor 114 may implement a specified token API after being registered with the token service provider 116. Various APIs may be used in connection with embodiments of the present disclosure. The token requestor 114 may be able to initiate a token request with the token service provider 116 in accordance with the processes and technologies specified within the API. The token request may be initiated by passing a token request message to the token service provider 116. The token request message may include token requestor information or token requestor ID, token domain restriction controls, PAN to be represented (e.g. replaced) by the token and, optionally, a requested token assurance method.

When the token service provider 116 processes the token request message sent by the token requestor 114, the token service provider 116 may issue a token. The issued token may be stored at the token vault 118 and provided to the token requestor 114. At the time of token generation, the token service provider 116 may identify and store a token-to-PAN mapping in the token vault 118 for use in subsequent transaction processing. The token vault 118 may also permanently associate each generated token with the token requestor 114 that initiated the request by capturing and storing the token requestor ID.

In some embodiments, tokens that are generated by the token service provider 116 may be accompanied by a token expiry date. The token expiry date may meet the format of a PAN expiry date and may be the same date or different date than the actual PAN. In various embodiments, tokens that are generated in response to a token request from the token requestor 114 are only valid for transactions within the token domain for which the token has been issued.

Accordingly, the token service provider 116 may be an entity within the tokenization ecosystem environment 100 that may be authorized to generate and/or provide tokens to the token requestor 114. In some embodiments, the token requestor 114 may be registered with the token service provider 116. According to various embodiments, the payment network 110, the issuer host 104 or an agent of the issuer host 104 may serve as the token service provider 116.

The token service provider 116 may be responsible for a number of discrete functions in its capacity as the authorized party for issuance of tokens. One or more of the functions of the token service provider 116 may be performed by the server computer 120. The token service provider 116 may be responsible for the ongoing operation and maintenance of the token vault 118 storing the generated tokens and a mapping between the tokens and PANS represented by the tokens. The token service provider 116 may be responsible for token generation and issuance, as well as application of security and controls to the generated tokens. The token service provider 116 may register the token requestor 114 and provision the generated token on requestor's devices.

The token service provider 116 may be responsible for building and/or managing its own proprietary application programming interface (API) for the token requestor 114, token vault 118, token provisioning platform, and token registry. The token service provider 116 may ensure that token BINs may be managed distinctly from traditional BINs, in part to avoid any inadvertent overlap of PANs and tokens. The token service provider 116 may generate a token using token BINs in such a way as to ensure the preservation of product and other attributes of the PAN throughout all existing transaction processes.

According to various embodiments, when the token service provider 116 issues a token for a PAN associated with an account, the account holder 102 may not know that the token has been issued to represent the account. In some embodiments, the account holder 102 may be asked to participate in the identification and verification (ID&V) process during token generation. For example, the account holder 102 may be asked to provide an identification information to ensure that the token is being generated for an account rightfully owned by the account holder 102.

Based on the type of the ID&V performed, the token service provider 116 also may generate a token assurance method associated with the generated token during the issuance of the token. The token assurance method may represent a level of trust in an association between the payment token and the PAN represented by the payment token. For example, a high token assurance method represents a trusted association of the token to the PAN from an authorized account holder, that may support secure and reliable payment transactions initiated with payment. The generated token assurance method may be different from the requested token assurance method that may be optionally provided to the token service provider 116 by the token requestor 114 in the token request message. In some embodiments, based on the type of ID&V performed or the entity performing the ID&V, the generated token assurance method may be the same as the requested token assurance method. Token assurance methods may change once assigned and may be recalculated based upon factors that may influence confidence levels such as reported fraud or fraud-related chargebacks, etc.

The token assurance method generated by the token service provider 116 may be based on the ID&V that was performed and the entity performing the ID&V. ID&V methods may be used singularly or in combination to provide a specific token assurance method. The token service provider 116 may implement one or more ID&V methods. Additionally, the token service provider 116 may ensure that the ID&V method(s) appropriate for the requested token assurance method are always performed when issuing a token.

ID&V steps may be performed by the token service provider 116, the token requestor 114, or a third party. In instances where the ID&V steps are performed by an entity other than the token service provider 116, verifiable evidence may be provided to prove that the steps were performed and the resulting outcomes were provided. Verifiable evidence may consist of any value provided to the token service provider 116 by the ID&V processing entity that the token service provider 116 may validate. Examples of verifiable evidence may include a cryptogram or an authorization code. These may apply to all ID&V methods, with the exception of conditions in which the ID&V is not performed. The token service provider 116 may set the token assurance method to the appropriate value(s) on the basis of the ID&V performed, and the token storage and usage information provided by the token requestor 114 at the time of token requestor registration.

According to various embodiments, the token assurance methods may range from no assurance to high assurance depending on the ID&V methodology performed, the entity performing the ID&V and the token service provider 116 that confirms the result of the assessment. Example ID&V methods may include, but are not limited to, (1) no ID&V performed, (2) account verification, (3) token service provider risk score, (4) token service provider risk score with token requestor data, and (5) issuer authentication of the account holder. One of ordinary skill in the art will appreciate that the foregoing ID&V methods are provided for illustration purposes only and that additional ID&V methods may be defined and performed in accordance with various embodiments.

### (1) No ID&V Performed

When a token is issued without any ID&V method being performed at the time of token issuance, the token assurance method may indicate (e.g. the token assurance method value may be set to) “No Assurance”. In some embodiments, no ID&V may result in the lowest token assurance method being assigned to the issued token. Depending on the token use case and token service provider rules, the token may still be used to initiate payment transactions, but may not carry any token assurance or may carry low token assurance. Additional restrictions for using tokens with no assurance level may be implemented according to various embodiments.

### (2) Account Verification

The account verification may represent an ID&V assurance method which provides a basic account verification check to validate if the PAN is active and valid. In various embodiments, the account verification may include: $0 authorization, card verification number validation, and postal code and address verification. The account verification method may be performed, for example, by the token requestor 114 and reported to the token service provider 116 through token service API. The account verification method may also be performed by the token service provider 116 at the time of the token issuance. When a token is issued by performing account verification at the time of token issuance, the token assurance method may indicate (e.g. the token assurance method value may be set to) “token requestor verification performed” or “token requestor assured”.

### (3) Token Service Provider Assurance

Token service provider assurance is a type of ID&V assurance method which involves the token service provider 116 performing a risk-based assessment of the likelihood that the request to tokenize a PAN is assured with sufficient level of confidence. The token service provider 116 may perform the risk-based assessment using the risk and authentication data maintained by the token service provider 116. When a token is issued with the token service provider assurance, the token assurance method may indicate (e.g. the token assurance method value may be set to) “Token Service Provider Assured”. In some embodiments, the token service provider assurance may result in a medium token assurance method being assigned to the issued token.

(4) Token Service Provider Assurance with Requestor Data

Token service provider assurance with requestor data is a ID&V assurance method which involves the use of data elements provided by the token requestor 114 that could be predictive of fraud. For example, the token requestor 114 may provide, among other information, account age and history, bill to/ship to addresses and contact information, IP address, device ID and device information, geo-location, and transaction velocity. The token service provider 116 may have appropriate assessment techniques and tools in place to implement this ID&V method and may combine the resulting ID&V data with the token service provider risk and authentication data related to the PAN to determine the assigned token assurance method. When a token is issued with the token service provider assurance with requestor data, the token assurance method may indicate (e.g. the token assurance method value may be set to) “Token Service Provider Assured with Requestor Data”. In some embodiments, the token service provider assurance may result in a medium token assurance method being assigned to the issued token.

### (5) Issuer Verification of the Account Holder

Issuer verification of the account holder is an ID&V method which involves interacting with the issuer host 104 or issuer agent(s) to perform account holder verification for satisfying the assurance necessary to complete the binding of the token to the PAN. Methods used for verification may be implemented to provide an acceptable user experience based on the device type (e.g., mobile phone, computer, etc.) that the account holder may use during the authentication process. In some embodiments, device guidelines may be created and followed to ensure a consistent user experience. The issuer authentication may be designed to leverage input data and scores from the token requestor 114 in order for the issuer host 104 to deliver the most intelligent experience possible to the account holder 102. The use of this data may allow the issuer host 104 to have confidence that the genuine and authorized account holder 102 is in fact requesting the token (or the token is being requested for the genuine and authorized account holder 102) without having to add extra steps to the process. The input data requested/obtained from the account holder 102 may include, among others, geo-location, device information, IP address, consumer information (e.g., email address, mobile phone number, landline phone number, confirmed shipping address, consumer ID&V, and age of customer relationship), and account information (e.g., length of time in wallet and/or account activity, such as none, recent, or not recent). When a token is issued with the issuer verification of the account holder, the token assurance method may indicate (e.g. the token assurance method value may be set to) “Issuer Assured”. In some embodiments, the issuer verification of the account holder may result in a high or the highest token assurance method being assigned to the issued token.

According to various embodiments, the issuer verification of the account holder may be performed via 3-D Secure Access Control Server (ACS), mobile banking verification of the account holder with an authentication code, federated login systems, API functionality capable of generating, delivering, and validating data from the token requestor and shared secrets, one-time password (OTP), activation code, or other shared secret between the issuer host 104 and the account holder 102. If the issuer host 104 determines that there is a need to verify the account holder 102 requesting the token through an explicit verification (e.g. using an OTP or activation code), the shared secret may be delivered to the account holder 102 through an out-of-band channel.

The issuer host 104 may use a plurality of methods for account holder authentication. According to some embodiments, static passwords and enrollment in an authentication service at the time of the account holder authentication may not be allowed for ID&V methods. In contrast, as provided above, one-time passwords may be used for account holder authentication by the issuer host 104. When an OTP is used, the issuer host 104 may require that the OTP has a length of at least 6 digits and no more than 8 digits, the OTP is generated using a uniform methodology, and the preferred method for delivery is a secure channel from the issuer host 104 to a consumer device of the account holder 102 (e.g. a mobile banking application installed on the consumer device).

Referring back to FIG. 1, when the token and the associated token assurance method are generated, the token service provider 116 may store the generated token, the PAN represented by the token, the token assurance method associated with the token, and data (e.g. the type of ID&V performed, the data used in performing the ID&V, the entity performing the ID&V, etc.) used to generate the token assurance method in a repository, such the token vault 118.

The token vault 118 may provide the capability for generation and issuance of tokens, establish and maintain token-to-PAN mapping, and provide underlying security and related processing controls, such as domain restrictions during transaction processing. The token vault 118 may provide the mechanism for token-to-PAN mapping to be made available during transaction processing such as authorization, clearing, and exception processing. The token vault 118 may need to maintain all associated tokens mapped to a given PAN throughout its lifecycle.

The token generated by the token service provider 116 may be provided to the token requestor 114 in response to the token request of the token requestor 114. As provided above, the token requestor 114 may be registered with the token service provider 116. The token service provider 116 may provide the generated token to the token requestor 114 when the token service provider 116 recognizes the token requestor ID assigned to the token requestor 114 during registration. Token issuance may also involve provisioning of the token to the token requestor 114. Token provisioning may occur after the token has been generated and the assurance steps are completed. Token provisioning may be performed through an interface between the token requestor 114 and the token service provider 116.

If the token requestor 114 is the account holder 102, upon receiving the token, the account holder 102 may present the token to the merchant 106 in a payment authorization request message. Alternatively, if the token requestor 114 is the merchant 106, the token may be directly provided to the merchant 106 by the token service provider 116. The merchant 106 may generate the payment authorization request message. The payment authorization request message may be for conducting a payment transaction using the primary account number represented by the token included in the payment authorization request message. The merchant 106 may send the payment authorization request message including the token to an acquirer host 108 for further processing.

The acquirer host 108 may be a system (acquirer computer or server) for an entity (e.g., a bank) that has a business relationship with the merchant 106. The acquirer host 108 may issue and manage a financial account for the merchant 106. In general, the acquirer host 108 may be responsible for authorization, capture, clearing and exception processing within the tokenization ecosystem environment 100. The acquirer host 108 may be communicatively coupled to the merchant 106 and the payment network 110. The acquirer host 108 computer may be configured to route the authorization request message including the token to the issuer host 104 computer via the payment network 110 computer. The acquirer host 108 computer may also route an authorization response message received from the issuer host 104 computer via the payment network 110 computer to the merchant 106 computer.

The payment network 110 (also referred as a payment processing network) may be communicatively coupled to the issuer host 104 and the acquirer host 108. The payment network 110 may be configured to provide authorization services, and clearing and settlement services for payment transactions. The payment network 110 may include data processing subsystems, wired or wireless networks, including the internet. The payment network 110 may include a server computer. In some implementations, the payment network 110 may forward the authorization request message received from the acquirer host 108 to the issuer host 104 via a communication channel. The authorization request message received from the acquirer host 108 may include a token.

The payment network 110 may communicate with the token service provider 116 to obtain a token assurance method associated with the token. The token assurance method may represent a level of trust in an association between the payment token and the PAN represented by the payment token. The token assurance method may be generated by the token service provider 116 when the token is generated, and stored in the token vault 118 along with the payment token. The payment network 110 may modify the authorization request message received from the acquirer host 108 to include the token assurance method and data (e.g. the type of ID&V performed, the data used in performing the ID&V, the entity performing the ID&V, etc.) used to generate the token assurance method. The payment network 110 may also modify the authorization request message to include the PAN represented by the token included in the authorization request message. The payment network 110 may then forward the modified authorization request message to the issuer host 104. The payment network 110 may receive an authorization response message from the issuer computer 170 and forward the received authorization response message to the acquirer host 108. In some embodiments, the payment network 110 may modify the authorization response message received from the issuer host 104 before forwarding the authorization response message to the acquirer host 108. For example, the payment network 110 may modify the authorization response message to remove the PAN (e.g. replace the PAN with the token), if the PAN was included in the authorization response message and may include the last 4 digits of the PAN in the authorization response message.

According to various embodiments, the payment network 110 may serve as the token service provider 116. The payment network 110 performing as the token service provider 116 may be responsible for building and/or managing their own proprietary token requestor API, token vault, token provisioning platform, and token registry. A payment network 110 that is not the token service provider 116 may support the implementation of processing functions that allow for the exchange of messages with the token service provider 116 for de-tokenization purposes to ensure token interoperability.

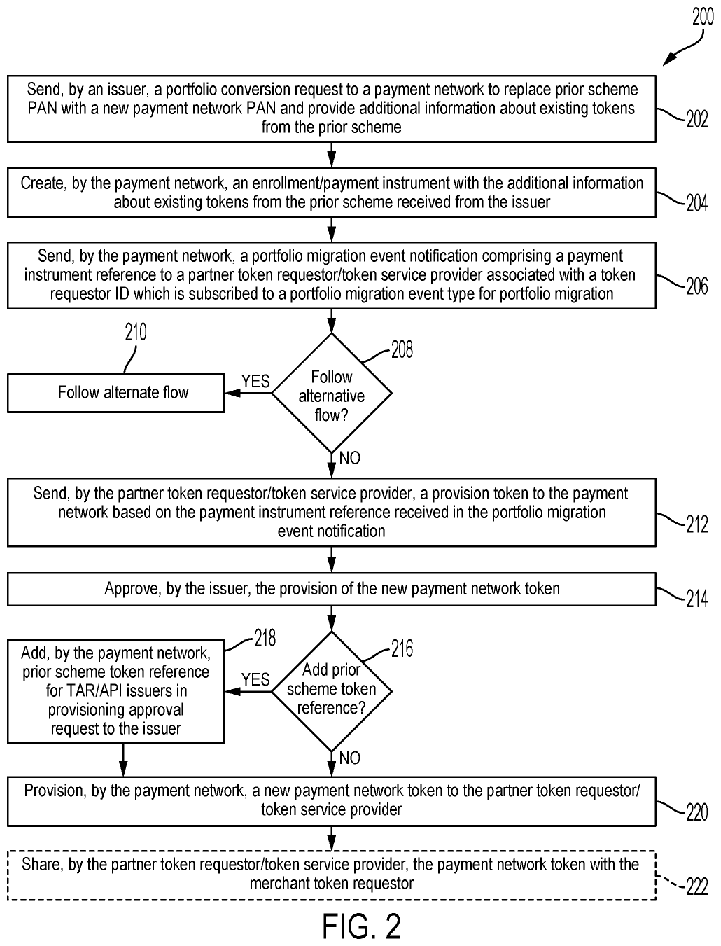

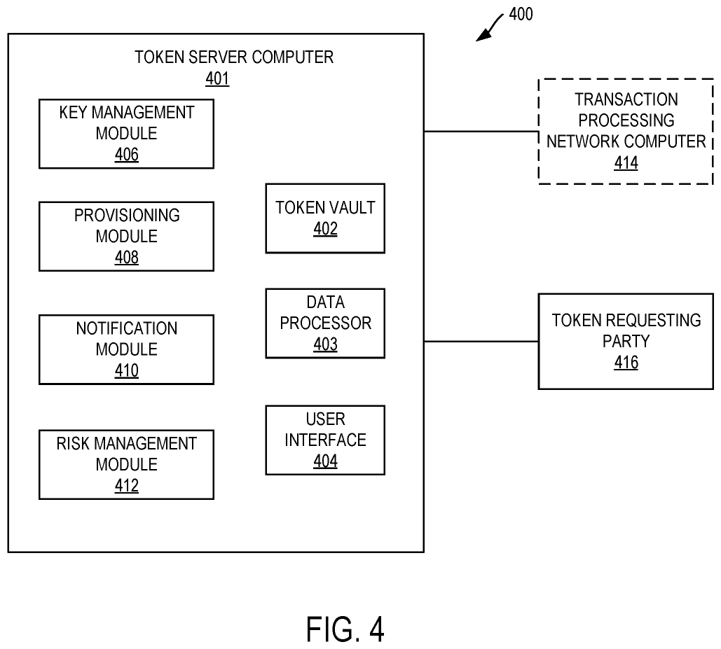

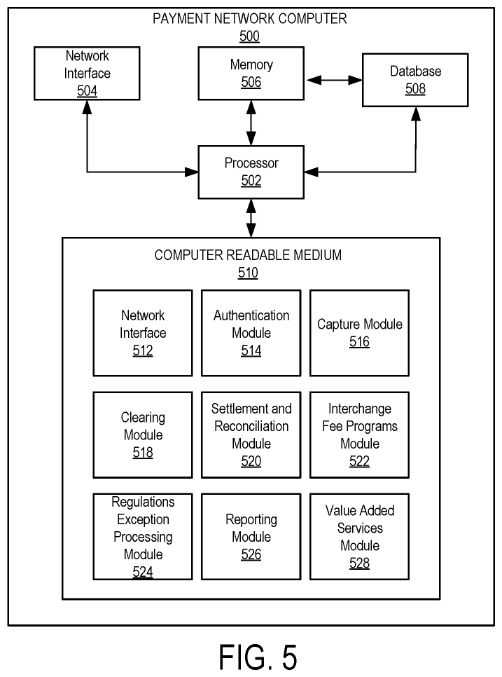

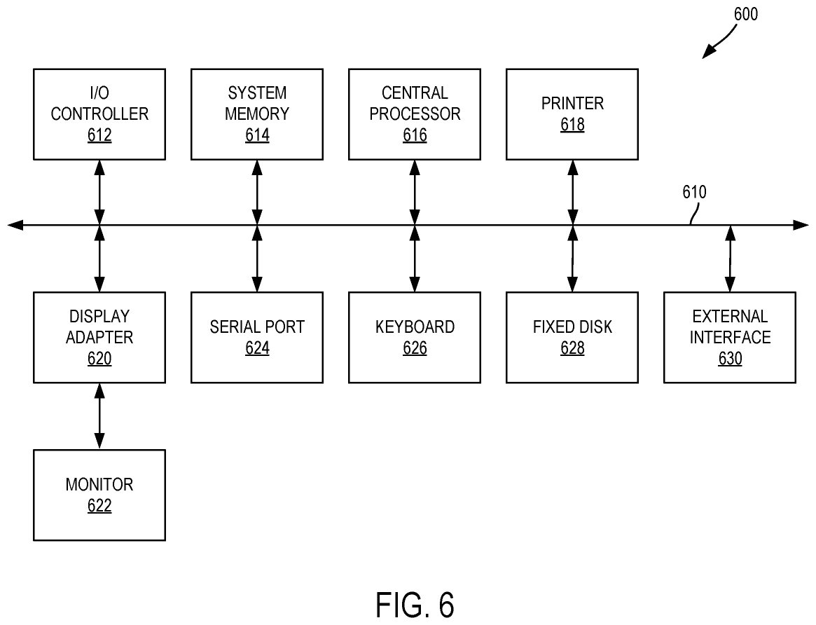

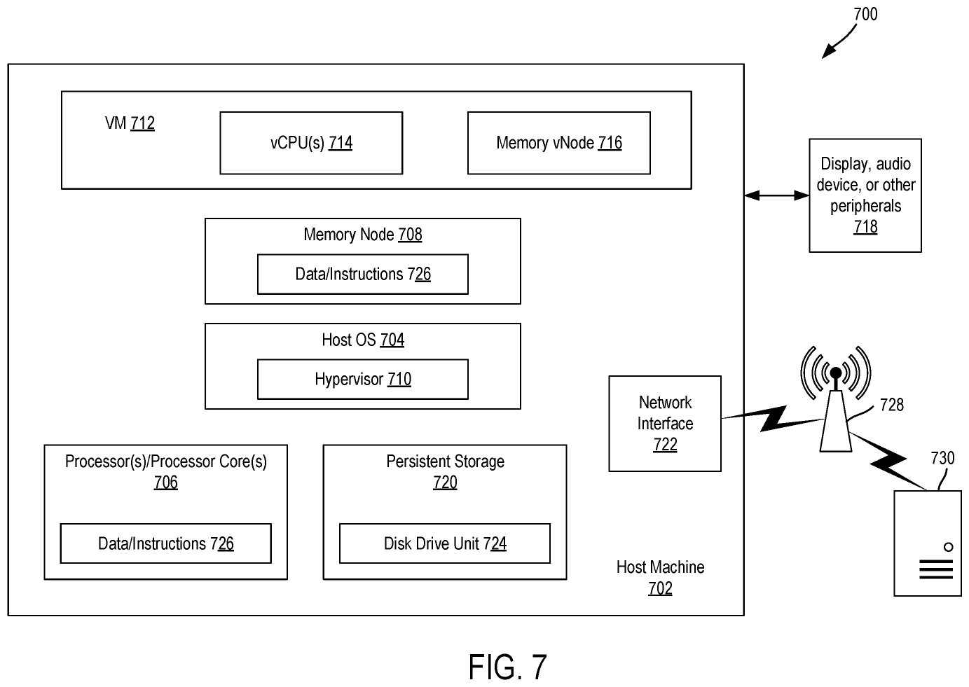

FIG. 2 is a logic flow diagram of a process 200 for portfolio migration via PAN life-cycle-management push provisioning, according to at least one aspect of the present disclosure. The process 200 may be implemented on the tokenization ecosystem environment 100 shown in FIG. 1. The functions described in connection with the process 200 may be executed by server computers or other computing devices of the account holder 102, issuer host 104, merchant 106, acquirer host 108, payment network 110, token service system 112, token requestor 114, and/or token service provider 116. A token server computer 401 implementation is shown in FIG. 4 and a payment network computer is shown in FIG. 5. The account holder 102, issuer host 104, merchant 106, acquirer host 108, token requestor 114, and/or token service provider 116 computers may implemented according to the computer apparatus 600 shown in FIG. 6 and system 700 shown in FIG. 7. The process 200 will now be described with reference to FIG. 2 together with FIG. 1.

An issuer host 104 sends 202 a portfolio conversion request to a payment network 110 to replace prior scheme PAN with a new payment network 110 PAN and provide additional information about existing tokens from the prior scheme to the payment network 110. The request includes an array of prior scheme token references, a list of prior scheme consumer references, and a payment network 110 token reference ID. The prior scheme token references may be comparable to the token network token network service system 112 token reference ID or it could be the token itself. The list of prior scheme consumer references may be comparable to the token network token network service system 112 client wallet account ID, but could also be other references such as list of email addresses. In one aspect, the issuer host 104 may employ a PAN lifecycle API with existing operation reason code of PORTFOLIO_CONVERSION to instruct to replace the old prior scheme PAN with a new payment network 110 PAN, the issuer host 104 also provides additional information about existing tokens from the prior scheme such as, for example, tokens and potentially multiple consumer references. The PAN lifecycle API additionally can be added to existing token lifecycle management (TLCM) online batch PAN update as an alternative to API for speed of conversion.

The payment network 110 creates 204 an enrollment/payment instrument with the additional information about existing tokens from the prior scheme received from the issuer host 104. The payment network 110 employs the array of prior scheme token references and the list of prior scheme consumer references to create the enrollments/payment instruments.

The payment network 110 sends 206 a portfolio migration event notification comprising a payment instrument reference to a partner token requestor 114/token service provider 116 associated with a token requestor 114 ID which is subscribed to a portfolio migration event type for portfolio migration. In one aspect, the portfolio migration event notification is sent to every token requestor 114/token service provider 116 associated with the token requestor 114 ID which is subscribed to the new event type. The new event type for the portfolio migration contains current token push provisioning event request data plus prior scheme meta data in the request body and a one time transaction ID to support a merchant 106 initiated transaction. In one aspect, a throttling mechanisms might be employed on the partner side to limit the amount of portfolio migration event notifications sent at once. In another aspect, the after employing the one time transaction ID in the first merchant initiated transaction on the payment network 110 credential, acquirers 108 will employ the transaction ID of that first transaction for future merchant 106 initiated transactions.

The partner token requestor 114/token service provider 116 determines 208 whether to follow an alternate token provisioning flow. If yes, follow alternate flow 210 for provisioning token. This is a potential decision to follow an alternative token provisioning flow, especially in case the partner token requestor 114/token service provider 116 is reliant on getting the payment network 110 PAN, for example a payment network 110 account updater inquiry (with a prior scheme PAN) or direct engagement with consumer to prompt for new payment network 110 card details followed by business as usual token provisioning.

The partner token requestor 114/token service provider 116 sends 212 a provision token to the payment network 110 based on the payment instrument reference received in the portfolio migration event notification. In one aspect, the partner token requestor 114/token service provider 116 who recognizes the prior scheme references sends the provision token to the payment network 110 given the PAN data API request to the payment network 110 using the payment instrument reference received in the portfolio migration event notification.

The issuer host 104 approves 214 the provision of the new payment network 110 token. In one aspect, the provision is a business as usual card-on-file/eCommerce token provisioning flow. Optionally, the payment network 110 determines 216 whether to add the prior scheme token reference. If yes, the payment network adds 218 the prior scheme token reference for TAR/API issuers in provisioning approval request to the issuer host 104. Otherwise or thereafter, the payment network 110 provisions 220 a new payment network token to the partner token requestor 114/token service provider 116. Optionally, the partner token requestor 114/token service provider 116 shares 222 the payment network 110 token with the merchant 106 token requestor.

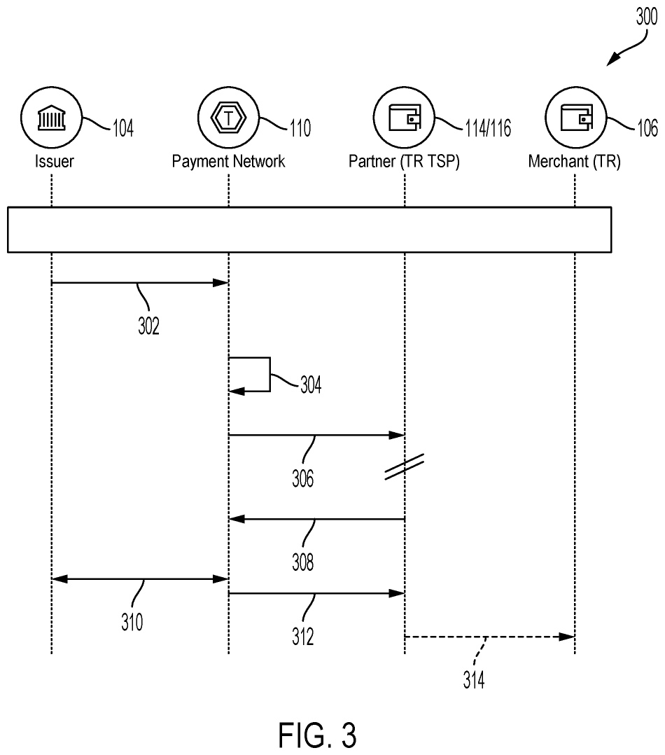

FIG. 3 is a swimlane diagram 300 of an implementation of the process 200 shown in FIG. 2, according to at least one aspect of the present disclosure. The functions described in connection with the swimlane diagram 300 may be executed by server computers or other computing devices of the account holder 102, issuer host 104, merchant 106, acquirer host 108, payment network 110, token service system 112, token requestor 114, and/or token service provider 116. A token server computer 401 implementation is shown in FIG. 4 and a payment network computer is shown in FIG. 5. The account holder 102, issuer host 104, merchant 106, acquirer host 108, token requestor 114, and/or token service provider 116 computers may implemented according to the computer apparatus 600 shown in FIG. 6 and system 700 shown in FIG. 7. The swimlane diagram 300 will now be described with reference to FIG. 3 together with FIG. 1.

An issuer host 104 sends 302 a portfolio conversion request to a payment network 110 to replace prior scheme PAN with a new payment network 110 PAN and provide additional information about existing tokens from the prior scheme to the payment network 110. The request includes an array of prior scheme token references, a list of prior scheme consumer references, and a payment network 110 token reference ID. The prior scheme token references may be comparable to the token network token network service system 112 token reference ID or it could be the token itself. The list of prior scheme consumer references may be comparable to the token network token network service system 112 client wallet account ID, but could also be other references such as list of email addresses. In one aspect, the issuer host 104 may employ a PAN lifecycle API with existing operation reason code of PORTFOLIO_CONVERSION to instruct to replace the old prior scheme PAN with a new payment network 110 PAN, the issuer host 104 also provides additional information about existing tokens from the prior scheme such as, for example, tokens and potentially multiple consumer references. The PAN lifecycle API additionally can be added to existing token lifecycle management (TLCM) online batch PAN update as an alternative to API for speed of conversion.

The payment network 110 creates 304 an enrollment/payment instrument with the additional information about existing tokens from the prior scheme received from the issuer host 104. The payment network 110 employs the array of prior scheme token references and the list of prior scheme consumer references to create the enrollments/payment instruments.

The payment network 110 sends 306 a portfolio migration event notification comprising a payment instrument reference to a partner token requestor 114/token service provider 116 associated with a token requestor 114 ID which is subscribed to a portfolio migration event type for portfolio migration. In one aspect, the portfolio migration event notification is sent to every token requestor 114/token service provider 116 associated with the token requestor 114 ID which is subscribed to the new event type. The new event type for the portfolio migration contains current token push provisioning event request data plus prior scheme meta data in the request body and a one time transaction ID to support a merchant 106 initiated transaction. In one aspect, a throttling mechanisms might be employed on the partner side to limit the amount of portfolio migration event notifications sent at once. In another aspect, the after employing the one time transaction ID in the first merchant initiated transaction on the payment network 110 credential, acquirers 108 will employ the transaction ID of that first transaction for future merchant 106 initiated transactions.

The partner token requestor 114/token service provider 116 determines whether to follow an alternate flow for provisioning a token, especially in case the partner token requestor 114/token service provider 116 is reliant on getting the payment network 110 PAN, for example a payment network 110 account updater inquiry (with a prior scheme PAN) or direct engagement with consumer to prompt for new payment network 110 card details followed by business as usual token provisioning.

The partner token requestor 114/token service provider 116 sends 308 a provision token to the payment network 110 based on the payment instrument reference received in the portfolio migration event notification. In one aspect, the partner token requestor 114/token service provider 116 who recognizes the prior scheme references sends the provision token to the payment network 110 given the PAN data API request to the payment network 110 using the payment instrument reference received in the portfolio migration event notification.

The issuer host 104 approves 310 the provision of the new payment network 110 token. In one aspect, the provision is a business as usual card-on-file/eCommerce token provisioning flow. Optionally, the payment network 110 determines whether to add the prior scheme token reference. If yes, the payment network adds the prior scheme token reference for TAR/API issuers in provisioning approval request to the issuer host 104. Otherwise or thereafter, the payment network 110 provisions 312 a new payment network token to the partner token requestor 114/token service provider 116. Optionally, the partner token requestor 114/token service provider 116 shares 314 the payment network 110 token with the merchant 106 token requestor.

FIG. 4 illustrates a block diagram of a tokenization environment 400 portion of the token network service system 112 described in FIG. 1, according to at least one aspect of the present disclosure. FIG. 4 will now be described together with FIG. 1. FIG. 4 illustrates an example of a tokenization environment 400 including a token server computer 401 of a token service provider 116. The token server computer 401 may be in communication with a token requesting party 416, such as, for example, the token requestor 114. The token requestor 114 may operate a token requestor computer, such as the computer apparatus 600 shown in FIG. 6. In some embodiments, the token server computer 401 also may be in communication with a transaction processing network computer 414 such as, for example, the payment network 110. In other embodiments, the token server computer 401 may part of the payment network 110. In various embodiments, the token server computer 401 is in communication with a payment network token gateway server computer.

The token server computer 401 may be responsible for provisioning a token using a provisioning module 408 in conjunction with a data processor 403. Provisioning may include creating a token within a token vault 402 for an account, such as, for example, the token vault 118, sending the token to the token requesting party 416 and sending the token to the payment network 110.

The token requesting party 416 may provide a set of account identifiers to the token server computer 401. The token server computer 401 may generate (or determine) a token for an account identifier operated by the token requesting party 416. The generated tokens may be stored at a token vault 402. The token vault 402 also may store a mapping between each token and the account identifier identifying the account represented by the token. The token vault 402 also may be used by the transaction processing network computer 414 to de-tokenize the token and convert the token to the account number represented by the token when a transaction authorization is processed through the transaction processing network computer 414. The token vault 402 also may manage all domain restrictions associated with each token provisioned.

The token requesting party 416 also may select, with the data processor 403 executing the key management module 406 of the token server computer 401, an option associated with encryption keys. For example, the token requesting party 416 may choose to provide the encryption keys to the token server computer 401 via the key management module 406. In some embodiments, the token requesting party 416 may choose to leave the key generation to the token server computer 401. The token server computer 401 may generate (or determine) the tokens based on the option associated with the encryption keys. The token server computer 401 may generate a token associated with at least one encryption key for each account identifier of the set of account identifiers. The token server computer 401 may store the encryption keys along with the associated tokens in the token vault 402. The encryption keys may then be provided to a user device of the account holder. The tokens and corresponding encryption keys may be used in tokenized transactions processed by the transaction processing network computer.

The token requesting party 416 also may initiate a request to receive a message when a token has been generated and/or provisioned for one of the accounts associated with the token requesting party 416. The token server computer 401 may generate a notification using the data processor 403 executing code in the notification module 410 based on the notification criteria (e.g., when a token satisfies the notification criteria) provided by the token requesting party 416. It also may send the notification to the token requesting party 416. For example, the token requesting party 416 may request a notification when a token is generated. The notification module 410 of the token server computer 401 may generate and send a notification to the token requesting party 416 when the token is generated. Similarly, the token requesting party 416 may request a notification when a token is provisioned on a user device. The notification module 410 of the token server computer 401 may generate and send a notification to the token requesting party 416 when the token is provisioned on the user device. For example, the notification module 410 may be informed by the provisioning module 408 that the token has been provisioned.

The token server computer 401 also may include a risk management module 412 that can work in conjunction with the data processor 403 to set up rules for risk decisioning when the token server computer 401 receives the token provisioning request from the token requesting party 416. As part of further customization of the token generation process, the token requesting party 416 may indicate rules for provisioning or processing the token based on a risk assessment associated with a transacting party, a device used in the transaction, or the account itself. In some embodiments, the token requesting party 416 may provide a restriction that is placed on one or more of the generated tokens based on the risk decision making rules.

The token server computer 401 shown in FIG. 4 is provided for illustration purposes and should not be construed as limiting. The token server computer 401 may include more or less components than those illustrated in FIG. 4. For example, the token server computer 401 may include additional software modules, such as a processing module, a lifecycle management module, etc. These and other modules may, in conjunction with the data processor 403, allow the token server computer 401 to perform one or more of the following functions: map an account identifier to a token and store the mapping in the token vault with relevant domain restrictions; provision a token from the token vault to a user device; manage (e.g., delete, suspend, resume, etc.) the token both at the token vault and on the user device; generate encryption keys based on the token requesting party's request; manage encryption keys based on predetermined criteria; process tokenized transactions including performing cryptogram validation, domain restriction checks, and validity checks; and perform post-transaction verification processing to verify that transactions and account updates are conducted on the user device after the transaction is processed by the transaction processing network.

In some embodiments, the token server computer 401 may support contactless payment use cases. This includes support for contactless payment methods using a secure element and Host Card Emulation (HCE)-based payment applications.

FIG. 5 shows a block diagram of a payment network computer 500, according to at least one aspect of the present disclosure. FIG. 5 illustrates components of the payment network computer 500, according to at least one aspect of the present disclosure. In some embodiments, the payment network 110 shown in FIGS. 1 and 2 may be implemented using or in a similar manner to the payment network computer 500.

The payment network computer 500 may include a processor 502 communicatively coupled to a network interface 504, a memory 506, a database 508, and a computer readable medium 510.

The network interface 504 may be configured to allow the payment network computer 500 to communicate with other entities such as an acquirer computer, a different payment processing network, an issuer computer, etc., using one or more communications networks.

The memory 506 may be used to store data. The memory 506 may be coupled to the processor 502 internally or externally (e.g., cloud based data storage) and may comprise any combination of volatile and/or non-volatile memory, for example, RAM, DRAM, ROM, flash, or any other suitable memory device.

The database 508 may store data associated with a plurality of consumers such as consumer personal and payment account information.

The computer readable medium 510 may be in the form of a memory (e.g., flash, ROM, etc.) and may comprise code, executable by the processor 502 for implementing methods described herein. The computer readable medium 510 may include an authorization module 512, an authentication module 514, a capture module 516, a clearing module 518, a settlement and reconciliation module 520, an interchange fee programs module 522, a regulations and exception processing module 524, a reporting module 526 and a value added services module 528.

The authorization module 512 may comprise code, executable by the processor 502 to validate token data elements, to provide a token assurance method, to provide support for lost and stolen devices and for token exchange.

The authorization module 512 may also comprise code, executable by the processor 502, to process an authorization request message comprising a token. In one embodiment, the authorization module 512, in conjunction with the processor 502, may validate the token requestor identifier to determine if the transaction can be approved or declined. For example, the token requestor identifier may be associated with a wallet application that may be used by a consumer to initiate a transaction using a consumer device. The token requestor identifier may be provided by the network token system to a wallet application during the onboarding process. In some embodiments, the authorization module 512 may approve or decline the transaction using various data associated with the transaction such as a token presentment mode, token number, token timestamp, token expiration date, token assurance method, a determination that the account used to conduct the transaction is lost, stolen, or compromised, or any other suitable data. The aforementioned data may be determined from the contents of the authorization request message for a transaction, a token registry database, or any other suitable source.

In one embodiment, the authorization module 512, working in conjunction with the processor 502, may provide support for token exchange. For example, the authorization module 512 may modify the authorization request message to replace the token with a PAN and send the modified authorization request message to an issuer. The authorization module 512 may also restore the token in the authorization response message received from the issuer before forwarding it to an acquirer computer. In some embodiments, records of the authorization may be contained in an authorization log database that can be transmitted to the participating acquirers. The data contained in the authorization log database can be in a plurality of file formats.

In some embodiments, the authorization module 512 may be configured to process payment transactions that use a token associated with a different payment network. For example, in some embodiments, the authorization module 512 may be configured to generate and send a token verification request to a payment network associated with the token, or specifically to a network token system associated with a payment network. The authorization module 512 may be further configured to receive a token verification response including the original PAN associated with the token and a validation result. The issuer associated with the original PAN may be determined, and an authorization request message for the transaction including the original PAN and the validation result may be sent to the issuer computer.

The authentication module 514 may comprise code that can be executed to the processor 502 to apply one or more authentication methods to authenticate token transactions based on the presentment modes. In one embodiment, the authentication module 514 may comprise code for authenticating the QR™ code token transactions using existing authentication schemes (e.g., entering personal information into a keypad). In another example, the authentication module 514 may comprise code for authenticating contactless EMV token transactions based on dCVVs that are formed with our without ATCs (Application Transaction Counters) or cryptograms.

The capture module 516 may comprise code for processing a capture file. For example, a merchant computer may send the token requestor identifier in the capture file that is sent to the acquirer computer. The payment network computer 500 can convert the token into a PAN and provide the PAN to the acquirer computer in the capture file to prepare clearing drafts pursuant to existing processing rules.

The clearing module 518 may be configured to process clearing transactions with tokens. A clearing process may be performed to reconcile orders among the transacting entities such as the issuer computer and the acquirer computer/merchant computer. When a token is used in a clearing draft message, a token requestor identifier may be present in the appropriate data field. In one embodiment, for Base II processing, the clearing module 518 can substitute clearing draft messages received with a token with the PAN for related clearing processing. In some embodiments, if the authorization was conducted with a token, the token is replaced with a PAN in the authorization data files provided to the acquirer computer. The token number and expiration date can be processed pursuant to existing rules and can be provided in the clearing draft message (e.g., in the expiration date field).

In some embodiments, the clearing draft message may include a token assurance method. In one embodiment, at the time of transaction processing, if the token requestor identifier is present, the token can be validated against the token requestor identifier to which the token was originally issued. If the validation fails, the payment processing network computer may return an appropriate code in the clearing draft message. In some embodiments, based on the issuer option of receiving the token requestor identifier, the payment processing network computer may forward the token requestor identifier in the clearing draft message to the issuer computer. In some embodiments, the acquirer computer may retain and return the token requestor identifier value used in the original transaction in all the subsequent transactions. In one embodiment, the POS condition code and the POS entry mode code fields can reflect the applicable token presentment mode in the clearing draft message.

The settlement and reconciliation module 520 may be configured to process settlement and reconciliation transactions with tokens. The settlement and reconciliation module 520 may provide support for the token requestor identifier and its validation in the reports and raw data files associated with the settlement and reconciliation processing of the transactions. In one embodiment, the settlement and reconciliation module 520 may include the tokens and the token requestor identifier in the reports and raw data files destined to the acquirer computer. In one embodiment, the settlement and reconciliation module 520 may include the real PAN and optionally the token requestor identifier in the reports and raw data files destined to the issuer computer. In some embodiments, the interface for processing transaction files (e.g., edit package) may be enhanced to process tokens in place of the PANs.

The interchange fee programs module 522 may comprise code for determining interchange rates and fees for token based transactions. Payment transactions conducted with tokens can qualify for existing fee programs and interchange rates applicable to the respective presentment modes and available card products.

The regulations/exception processing module 524 may be configured to apply operating regulations and perform liability and dispute processing for token payment transactions. Payment transactions with tokens can qualify for existing liability rules applicable to the respective presentment modes and available card products. For example, acquires and issuers can qualify for existing chargeback rules based on the presentment modes. The regulations/exception processing module 524 can map the tokens used in the original transactions to facilitate dispute processing related to chargebacks.

The reporting module 526 may be configured to provide reporting for token payment transactions. In some embodiments, the reporting module 826 may provide reports for each country and regions based on token attributes such as the token number and token ranges, token requestor identifier, consumer token assurance method, token expiration date, COF (card on file) indicator and the token presentment mode.

The value added services module 528 may comprise code for supporting value added services to support token transactions. For example, account update functions of merchant enquiry and setup of payment controls can be supported for tokens.

FIG. 6 is a block diagram of a computer apparatus 600 with data processing subsystems or components, according to at least one aspect of the present disclosure. The subsystems shown in FIG. 6 are interconnected via a system bus 610. Additional subsystems such as a printer 618, keyboard 626, fixed disk 628 (or other memory comprising computer readable media), monitor 622, which is coupled to a display adapter 620, and others are shown. Peripherals and input/output (I/O) devices, which couple to an I/O controller 612 (which can be a processor or other suitable controller), can be connected to the computer system by any number of means known in the art, such as a serial port 624. For example, the serial port 624 or external interface 630 can be used to connect the computer apparatus to a wide area network such as the Internet, a mouse input device, or a scanner. The interconnection via system bus allows the central processor 616 to communicate with each subsystem and to control the execution of instructions from system memory 614 or the fixed disk 628, as well as the exchange of information between subsystems. The system memory 614 and/or the fixed disk 628 may embody a computer readable medium.

FIG. 7 is a diagrammatic representation of an example of a system 700 that includes a host machine 702 within which a set of instructions to perform any one or more of the methodologies discussed herein may be executed, according to at least one aspect of the present disclosure. In various aspects, the host machine 702 operates as a standalone device or may be connected (e.g., networked) to other machines. In a networked deployment, the host machine 702 may operate in the capacity of a server or a client machine in a server-client network environment, or as a peer machine in a peer-to-peer (or distributed) network environment. The host machine 702 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The system 700 includes the host machine 702, running a host operating system (OS) 704 on a processor or multiple processor(s)/processor core(s) 706 (e.g., a central processing unit (CPU), a graphics processing unit (GPU), or both), and various memory nodes 708. The host OS 704 may include a hypervisor 710 which is able to control the functions and/or communicate with a virtual machine (“VM”) 712 running on machine readable media. The VM 712 also may include a virtual CPU or vCPU 714. The memory nodes 708 may be linked or pinned to virtual memory nodes or vNodes 716. When the memory node 708 is linked or pinned to a corresponding vNode 716, then data may be mapped directly from the memory nodes 708 to their corresponding vNodes 716.

All the various components shown in host machine 702 may be connected with and to each other, or communicate to each other via a bus (not shown) or via other coupling or communication channels or mechanisms. The host machine 702 may further include a video display, audio device or other peripherals 718 (e.g., a liquid crystal display (LCD), alphanumeric input device(s) including, e.g., a keyboard, a cursor control device, e.g., a mouse, a voice recognition or biometric verification unit, an external drive, a signal generation device, e.g., a speaker,) a persistent storage device 720 (also referred to as disk drive unit), and a network interface device 722. The host machine 702 may further include a data encryption module (not shown) to encrypt data. The components provided in the host machine 702 are those typically found in computer systems that may be suitable for use with aspects of the present disclosure and are intended to represent a broad category of such computer components that are known in the art. Thus, the system 700 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 724 also may be a Solid-state Drive (SSD), a hard disk drive (HDD) or other includes a computer or machine-readable medium on which is stored one or more sets of instructions and data structures (e.g., data/instructions 726) embodying or utilizing any one or more of the methodologies or functions described herein. The data/instructions 726 also may reside, completely or at least partially, within the main memory node 708 and/or within the processor(s) 706 during execution thereof by the host machine 702. The data/instructions 726 may further be transmitted or received over a network 728 via the network interface device 722 utilizing any one of several well-known transfer protocols (e.g., Hyper Text Transfer Protocol (HTTP)).

The processor(s) 706 and memory nodes 708 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 702 and that causes the host machine 702 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 1030 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 702, with each server 730 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

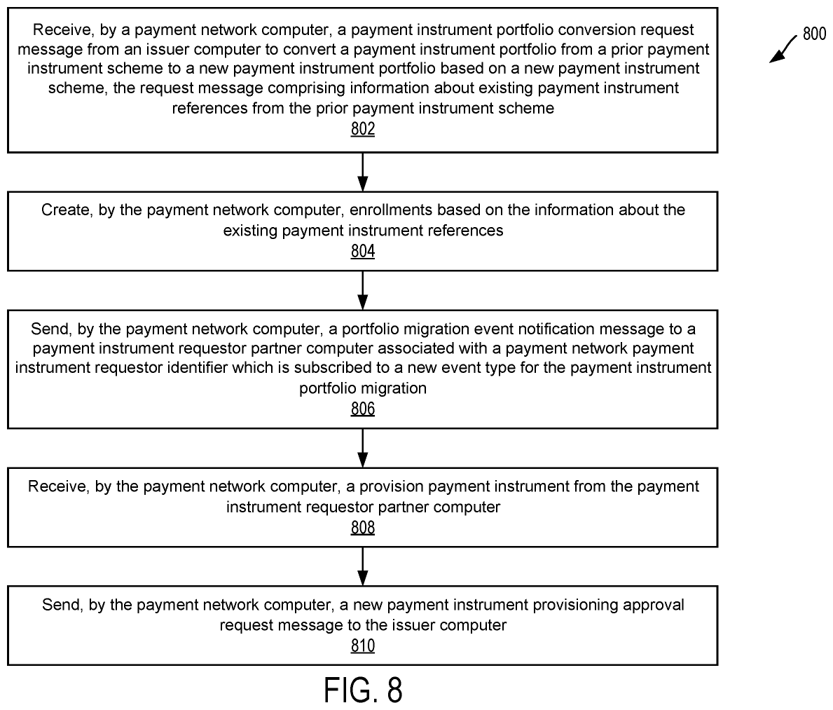

FIG. 8 is a logic flow diagram of a process 800 for portfolio migration via PAN life-cycle-management push provisioning, according to at least one aspect of the present disclosure. The process 800 will be described together with FIG. 5. A payment network computer 500 receives 802 a payment instrument portfolio conversion request message from an issuer computer to convert a payment instrument portfolio from a prior payment instrument scheme to a new payment instrument portfolio based on a new payment instrument scheme, the request message comprising information about existing payment instrument references from the prior payment instrument scheme. The payment network computer 500 creates 804 enrollments based on the information about the existing payment instrument references. The payment network computer 500 sends 806 a portfolio migration event notification message to a payment instrument requestor partner computer associated with a payment network payment instrument requestor identifier which is subscribed to a new event type for the payment instrument portfolio migration. The payment network computer 500 receives 808 a provision payment instrument from the payment instrument requestor partner computer. The payment network computer 500 sends 810 a new payment instrument provisioning approval request message to the issuer computer.

In other aspects of the process 800, the payment instrument portfolio conversion request message comprises a list of consumer references from the prior payment instrument scheme and the payment network payment instrument requestor identifier and wherein creating the enrollments is based on the list of consumer references and the payment network payment instrument requestor identifier.

In other aspects of the process 800, the new event type for the payment instrument portfolio migration comprises current push provisioning event request data for the current payment instrument and meta data associated with the prior scheme.

In other aspects of the process 800, the provision payment instrument comprises a payment instrument reference received in the payment instrument portfolio conversion request message, and wherein the provision payment instrument is based on the payment instrument portfolio conversion request message from the issuer computer to the payment network computer using a payment instrument reference received in the portfolio migration event notification message.

In other aspects of the process 800, the payment instrument requestor partner computer identifies the information about existing payment instrument references from the prior payment instrument scheme.

In other aspects of the process 800, the payment network computer 500 receives approval of the provisioning of the new payment instrument provisioning approval from the issuer computer; and sends the new payment instrument to the payment instrument requestor partner computer, wherein the new payment instrument comprises a prior scheme payment instrument reference for TAR/API issuers in provisioning approval request to the issuer.

In other aspects of the process 800, the payment instrument requestor partner computer comprising shares the new payment instrument with a merchant payment instrument requestor computer.

In other aspects of the process 800, wherein the payment instrument is a token.

In other aspects of the process 800, the payment instrument requestor is a payment instrument service provider.

In other aspects of the process 800, the payment network computer 500 receives the payment instrument portfolio request message from a primary account number (PAN) lifecycle management (LCM) API executable on the issuer computer.

Examples of the method according to various aspects of the present disclosure are provided below in the following numbered clauses. An aspect of the method may include any one or more than one, and any combination of, the numbered clauses described below.

Clause 1. A method of migrating a payment instrument portfolio, the method comprising receiving, by a payment network computer, a payment instrument portfolio conversion request message from an issuer computer to convert a payment instrument portfolio from a prior payment instrument scheme to a new payment instrument portfolio based on a new payment instrument scheme, the request message comprising information about existing payment instrument references from the prior payment instrument scheme; creating, by the payment network computer, enrollments based on the information about the existing payment instrument references; sending, by the payment network computer, a portfolio migration event notification message to a payment instrument requestor partner computer associated with a payment network payment instrument requestor identifier which is subscribed to a new event type for the payment instrument portfolio migration; receiving, by the payment network computer, a provision payment instrument from the payment instrument requestor partner computer; and sending, by the payment network computer, a new payment instrument provisioning approval request message to the issuer computer.

Clause 2. The method of clause 1, wherein the payment instrument portfolio conversion request message comprises a list of consumer references from the prior payment instrument scheme and the payment network payment instrument requestor identifier and wherein creating the enrollments is based on the list of consumer references and the payment network payment instrument requestor identifier.

Clause 3. The method of any one of clauses 1 or 2, wherein the new event type for the payment instrument portfolio migration comprises current push provisioning event request data for a current payment instrument and meta data associated with the prior scheme.

Clause 4. The method of any one of clauses 1 to 3, wherein the provision payment instrument comprises a payment instrument reference received in the payment instrument portfolio conversion request message, and wherein the provision payment instrument is based on the payment instrument portfolio conversion request message from the issuer computer to the payment network computer using a payment instrument reference received in the portfolio migration event notification message.

Clause 5. The method of any one of clause 1 to 4, comprising, identifying, by the payment instrument requestor partner computer, the information about existing payment instrument references from the prior payment instrument scheme.

Clause 6. The method of any one of clauses 1 to 5, comprising receiving, by the payment network computer, approval of the provisioning of the new payment instrument provisioning approval from the issuer computer; and sending, by the payment network computer, the new payment instrument to the payment instrument requestor partner computer, wherein the new payment instrument comprises a prior scheme payment instrument reference for TAR/API issuers in provisioning approval request to the issuer.

Clause 7. The method of clause 6, comprising sharing, by the payment instrument requestor partner computer, the new payment instrument with a merchant payment instrument requestor computer.

Clause 8. The method of any one of clauses 1 to 7, wherein the payment instrument is a token.

Clause 9. The method of any one of clauses 1 to 8, wherein the payment instrument requestor is a payment instrument service provider.

Clause 10. The method of any one of clauses 1 to 9, comprising receiving, by the payment network computer, the payment instrument portfolio request message from a primary account number (PAN) lifecycle management (LCM) API executable on the issuer computer.

Clause 11. A system for migrating a payment instrument portfolio, the system comprising a payment network computer comprising a processor and a memory for storing machine executable instructions that when executed by the processor cause the processor to receive a payment instrument portfolio conversion request message from an issuer computer to convert a payment instrument portfolio from a prior payment instrument scheme to a new payment instrument portfolio based on a new payment instrument scheme, the request message comprising information about existing payment instrument references from the prior payment instrument scheme; create enrollments based on the information about the existing payment instrument references; send a portfolio migration event notification message to a payment instrument requestor partner computer associated with a payment network payment instrument requestor identifier which is subscribed to a new event type for the payment instrument portfolio migration; receive a provision payment instrument from the payment instrument requestor partner computer; and send a new payment instrument provisioning approval request message to the issuer computer.

Clause 12. The system of clause 11, wherein the machine executable instructions when executed by the processor cause the processor to receive approval of the provisioning of the new payment instrument provisioning approval from the issuer computer; and send the new payment instrument to the payment instrument requestor partner computer, wherein the new payment instrument comprises a prior scheme payment instrument reference for TAR/API issuers in provisioning approval request to the issuer.

Clause 13. The system of clause 11 or 12, wherein the machine executable instructions when executed by the processor cause the processor to receive the payment instrument portfolio request message from a primary account number (PAN) lifecycle management (LCM) API executable on the issuer computer.

Clause 14. A system for migrating a payment instrument portfolio, the system comprising a payment network computer to create enrollments based on information about existing payment instrument references; send a portfolio migration event notification message to a payment instrument requestor partner computer associated with a payment network payment instrument requestor identifier which is subscribed to a new event type for the payment instrument portfolio migration; and receive a provision payment instrument from the payment instrument requestor partner computer.

Clause 15. The system of clause 14, comprising an issuer computer to send a payment instrument portfolio conversion request message to the payment network computer to convert a payment instrument portfolio from a prior payment instrument scheme to a new payment instrument portfolio based on a new payment instrument scheme, the request message comprising information about existing payment instrument references from the prior payment instrument scheme; and receive a new payment instrument provisioning approval request message from the payment network computer.

Clause 16. The system of clause 15, wherein the provision payment instrument comprises a payment instrument reference received in the payment instrument portfolio conversion request message, and wherein the provision payment instrument is based on the payment instrument portfolio conversion request message from the issuer computer to the payment network computer using a payment instrument reference received in the portfolio migration event notification message.

Clause 17. The system of any one of clauses 15 or 16, wherein the issuer computer is to send approval of the provisioning of the new payment instrument provisioning approval to the payment network computer.

Clause 18. The system of any one of clauses 15 to 17, wherein the issuer computer is to send the payment instrument portfolio request message to the payment network computer from a primary account number (PAN) lifecycle management (LCM) API executable on the issuer computer.

Clause 19. The system of any one of clauses 14 to 18, comprising a payment instrument requestor partner computer to identify the information about existing payment instrument references from the prior payment instrument scheme.

Clause 20. The system of clause 19, wherein the issuer computer is to send approval of the provisioning of the new payment instrument provisioning to the payment network computer; and the payment network computer is to send a new payment instrument to the payment instrument requestor partner computer, wherein the new payment instrument comprises a prior scheme payment instrument reference for TAR/API issuers in provisioning approval request to the issuer.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A method of migrating a payment instrument portfolio, the method comprising:
receiving, by a payment network computer, a payment instrument portfolio conversion request message from an issuer computer to convert a payment instrument portfolio from a prior payment instrument scheme to a new payment instrument portfolio based on a new payment instrument scheme, the request message comprising information about existing payment instrument references from the prior payment instrument scheme;
creating, by the payment network computer, enrollments based on the information about the existing payment instrument references;
sending, by the payment network computer, a portfolio migration event notification message to a payment instrument requestor partner computer associated with a payment network payment instrument requestor identifier which is subscribed to a new event type for the payment instrument portfolio migration;
receiving, by the payment network computer, a provision payment instrument from the payment instrument requestor partner computer; and
sending, by the payment network computer, a new payment instrument provisioning approval request message to the issuer computer.

2. The method of claim 1, wherein the payment instrument portfolio conversion request message comprises a list of consumer references from the prior payment instrument scheme and the payment network payment instrument requestor identifier and wherein creating the enrollments is based on the list of consumer references and the payment network payment instrument requestor identifier.

3. The method of claim 1, wherein the new event type for the payment instrument portfolio migration comprises current push provisioning event request data for a current payment instrument and meta data associated with the prior scheme.

4. The method of claim 1, wherein the provision payment instrument comprises a payment instrument reference received in the payment instrument portfolio conversion request message, and wherein the provision payment instrument is based on the payment instrument portfolio conversion request message from the issuer computer to the payment network computer using a payment instrument reference received in the portfolio migration event notification message.

5. The method of claim 1, comprising, identifying, by the payment instrument requestor partner computer, the information about existing payment instrument references from the prior payment instrument scheme.

6. The method of claim 1, comprising:
receiving, by the payment network computer, approval of the provisioning of the new payment instrument provisioning approval from the issuer computer; and
sending, by the payment network computer, the new payment instrument to the payment instrument requestor partner computer, wherein the new payment instrument comprises a prior scheme payment instrument reference for TAR/API issuers in provisioning approval request to the issuer.

7. The method of claim 6, comprising sharing, by the payment instrument requestor partner computer, the new payment instrument with a merchant payment instrument requestor computer.

8. The method of claim 1, wherein the payment instrument is a token.

9. The method of claim 1, wherein the payment instrument requestor is a payment instrument service provider.

10. The method of claim 1, comprising receiving, by the payment network computer, the payment instrument portfolio request message from a primary account number (PAN) lifecycle management (LCM) API executable on the issuer computer.

11. A system for migrating a payment instrument portfolio, the system comprising:
a payment network computer comprising a processor and a memory for storing machine executable instructions that when executed by the processor cause the processor to:
receive a payment instrument portfolio conversion request message from an issuer computer to convert a payment instrument portfolio from a prior payment instrument scheme to a new payment instrument portfolio based on a new payment instrument scheme, the request message comprising information about existing payment instrument references from the prior payment instrument scheme;
create enrollments based on the information about the existing payment instrument references;
send a portfolio migration event notification message to a payment instrument requestor partner computer associated with a payment network payment instrument requestor identifier which is subscribed to a new event type for the payment instrument portfolio migration;
receive a provision payment instrument from the payment instrument requestor partner computer; and
send a new payment instrument provisioning approval request message to the issuer computer.

12. The system of claim 11, wherein the machine executable instructions when executed by the processor cause the processor to:
receive approval of the provisioning of the new payment instrument provisioning approval from the issuer computer; and
send the new payment instrument to the payment instrument requestor partner computer, wherein the new payment instrument comprises a prior scheme payment instrument reference for TAR/API issuers in provisioning approval request to the issuer.

13. The system of claim 11, wherein the machine executable instructions when executed by the processor cause the processor to receive the payment instrument portfolio request message from a primary account number (PAN) lifecycle management (LCM) API executable on the issuer computer.

14. A system for migrating a payment instrument portfolio, the system comprising:
a payment network computer to:
create enrollments based on information about existing payment instrument references;
send a portfolio migration event notification message to a payment instrument requestor partner computer associated with a payment network payment instrument requestor identifier which is subscribed to a new event type for the payment instrument portfolio migration; and
receive a provision payment instrument from the payment instrument requestor partner computer.

15. The system of claim 14, comprising:
an issuer computer to:
send a payment instrument portfolio conversion request message to the payment network computer to convert a payment instrument portfolio from a prior payment instrument scheme to a new payment instrument portfolio based on a new payment instrument scheme, the request message comprising information about existing payment instrument references from the prior payment instrument scheme; and
receive a new payment instrument provisioning approval request message from the payment network computer.

16. The system of claim 15, wherein the provision payment instrument comprises a payment instrument reference received in the payment instrument portfolio conversion request message, and wherein the provision payment instrument is based on the payment instrument portfolio conversion request message from the issuer computer to the payment network computer using a payment instrument reference received in the portfolio migration event notification message.

17. The system of claim 15, wherein the issuer computer is to send approval of the provisioning of the new payment instrument provisioning approval to the payment network computer.

18. The system of claim 15, wherein the issuer computer is to send the payment instrument portfolio request message to the payment network computer from a primary account number (PAN) lifecycle management (LCM) API executable on the issuer computer.

19. The system of claim 14, comprising:
a payment instrument requestor partner computer to identify the information about existing payment instrument references from the prior payment instrument scheme.

20. The system of claim 19, wherein the issuer computer is to send approval of the provisioning of the new payment instrument provisioning to the payment network computer; and
the payment network computer is to send a new payment instrument to the payment instrument requestor partner computer, wherein the new payment instrument comprises a prior scheme payment instrument reference for TAR/API issuers in provisioning approval request to the issuer.
